(19) United States
(12) Patent Application Publication
(10) Pub. No.: US 2024/0206491 A1
(43) Pub. Date: Jun. 27, 2024

(54) FERMENTED FOOD PRODUCT

(71) Applicant: Stockeld Dreamery AB, Solna (SE)

(72) Inventors: Anja Malin Leissner, Solna (SE); Raquel Ferrari Rodrigues de Pina, Solna (SE); Lubica Macakova, Solna (SE)

(21) Appl. No.: 18/556,693

(22) PCT Filed: Apr. 26, 2022
(86) PCT No.: PCT/EP2022/061092

§ 371 Date: Oct. 23, 2023

(30) Foreign Application Priority Data
Apr. 26, 2021 (EP) 21170508.2

(51) Int. Cl. A23C 20/02; A23D 7/005; A23J 3/14; A23L 11/50

(52) U.S. Cl. CPC A23C 20/025; A23D 7/0053; A23J 3/14; A23L 11/50

(57) ABSTRACT

The invention provides an oil-in-water emulsion comprising a mixture of legume protein isolates and a vegetable fat, as well as fermented food products prepared by fermentation of said emulsion. The mixture of legume protein isolates comprises a first legume protein isolate having a solubility of the proteins of at least 25% and a second legume protein isolate having a solubility of the proteins of less than 20%, wherein the second legume protein isolate constitutes in the range of 20 to 70 wt % of the total first and second legume protein isolates.

### TECHNICAL FIELD

The invention relates to a plant based, fermented food product. In particular, the fermented food product may have properties similar to cheese, such as properties similar to feta cheese. The fermented food product may be based on mixtures of legume protein, for example pea and fava bean protein, and typically comprises a mixture of legume protein isolates, vegetable fat and water.

### BACKGROUND

Consumer preferences in the Western world are starting to shift away from high consumption of animal-sourced foods, and towards higher consumption of plant based foods. Younger generations seem to spearhead this change, driven by e.g. environmental, health, and animal welfare concerns. This trend started with realistic plant based alternatives to meat and dairy, and is now increasingly seen also for plant based alternatives to fish, egg and cheese.

Conventional cheese is made with milk from cow, goat, sheep, buffalo or moose but there has been a distinct increase in demand for plant based cheese products that can measure up to their animal-based peers. However, many of the commercially available plant based cheese alternatives are severely lacking in nutritional profile as well as in taste experience, such as melting behaviour, mouthfeel, flavour and texture. Poor alternatives to animal-sourced cheeses is a major obstacle blocking consumers to adopt a fully plant based diet. The market potential for plant based cheese alternatives is very attractive since none of the commercially available products have been able to attract repeat customers outside the vegan community to any larger extent.

To develop compelling options to animal-sourced cheese, the key challenge boils down to successfully replicating the specific characteristics of the milk proteins—especially casein—and the milk fat which result in delicious and nutritious products when processed during the production of cheese. The milk proteins have no equivalents in functional behaviour in the plant kingdom since they are fundamentally different and this poses a large obstacle in the development of new plant based cheese alternatives.

In the U.S., plant based milk currently accounts for 15% of all dollar sales of retail milk —but plant based cheese is less than 1% of all dollar sales of retail cheese. The appearance, texture, flavour and/or mouthfeel of currently available cheese substitutes have simply not managed to appeal sufficiently to consumers.

In addition, many of the currently available dairy substitutes have significantly poorer nutritional composition and profile (incl. bioavailability of nutrients), than their animal-sourced peers. Thus, when developing plant based analogues to dairy products, they must meet consumer expectations both in terms of taste, but also in terms of nutritional value.

On top of the requirement to the functional and nutritional properties of the plant based proteins and plant based products, there are also certain requirements to sustainability during plant cultivation. Environmentally friendly cultivation is of high importance both for environment and consumers. Soy protein, which is being used extensively, is often produced in unsustainable manners, and therefore use of alternative, preferably locally grown proteins, are desired.

### SUMMARY

There is thus an unmet need for methods for the production of plant based products with properties similar to cheese with a taste and nutritional value at least comparable to, but preferably superior to diary based cheeses.

The present inventors have found that the oil-in-water emulsions with high emulsion capacity and good gelling properties are particularly suitable as starting material for production of fermented food products with properties similar to cheese. In particular, the inventors have found that oil-in-water emulsions comprising certain mixtures of legume protein isolates have high emulsion capacity and good gelling properties. When fermenting such oil-in-water emulsions, superior cheese analogues can be produced.

Said mixture of legume protein isolates preferably comprises two different kinds of legume protein isolates, herein denoted “first legume protein isolate” and “second legume protein isolate. Preferably, the first legume protein isolate has a solubility of the proteins of at least 25% and the second legume protein isolate has a solubility of the proteins of less than 20%, wherein the second legume protein isolate constitutes in the range of 20 to 70% of the total first and second legume protein isolates.

Thus, the invention provides fermented food products comprising:
a) a mixture of legume protein isolates comprising a first legume protein isolate and a second legume protein isolate, wherein the first legume protein isolate has a solubility of the proteins of at least 25% and the second legume protein isolate has a solubility of the proteins of less than 20%, wherein the second legume protein isolate constitutes in the range of 20 to 70 wt % of the total first and second legume protein isolates,
b) a vegetable fat, and
c) water
wherein the product comprises at least 2% proteins.

The invention also provides oil-in-water emulsions comprising
a) a mixture of legume protein isolates comprising a first legume protein isolate and a second legume protein isolate, wherein the first legume protein isolate has a solubility of the proteins of at least 25% and the second legume protein isolate has a solubility of the proteins of less than 20%, wherein the second legume protein isolate constitutes in the range of 20 to 70 wt % of the total first and second legume protein isolates,
b) a vegetable fat, and
c) water
wherein the oil-in-water emulsion comprises at least 2% protein.

The first legume protein may be either a legume protein isolate with high protein concentration or a legume protein concentrate with lower protein concentration. In preferred embodiments, it is a legume protein high concentration isolate. Similarly, the second legume protein isolate may be either a legume protein high concentration isolate or a legume protein concentrate. In preferred embodiments, the second legume protein isolate is a legume protein high concentration isolate.

The invention further provides methods of producing aforementioned fermented food product or oil-in-eater emulsion.

### DESCRIPTION OF DRAWINGS

FIG. 1 shows an example of a fermented food product according to the invention

FIG. 2 shows the nutritional profile of a fermented food product prepared as described in Example 1 compared with conventional feta cheese.

FIG. 3 shows the emulsion stability after 2 hours of 15 wt % oil-in-water emulsions, stabilized by solutions of pea protein (Pea protein 2) having 1.5 wt %, 0.75 wt %, 0.15 wt % and 0.03 wt % of pea protein.

FIG. 4 shows an example of the force vs compression distance curve obtained by texture analyser for gel formed by 15% solution of a pea protein isolate (Pea protein 1) with schematic illustration of different analysed parameters.

### DETAILED DESCRIPTION

### Definitions

The term “comprising” as used herein is to be interpreted as specifying the presence of the stated features, steps, or components as referred to, but does not preclude the presence or addition of one or more additional features, steps or components, or groups thereof. When a composition comprises a specified range or a maximum level of a given compound, the term comprising is to be interpreted such that said composition may comprise other compounds or components in addition to said given compound, but not more than the upper limit of said range or more than said maximum level of said given compound.

The term “emulsion” as used herein refers to a colloidal system made of two non-miscible elements, for example a lipid phase (e.g. oil or fat) and an aqueous phase. One element (the dispersed phase) is present in the form of droplets dispersed in the other element, constituting the continuous phase. Unless otherwise mentioned in the present disclosure, the term “emulsion” is understood as indicating both a water-in-oil emulsion and an oil-in-water emulsion.

The term “emulsification” as used herein refers to the process where aqueous protein isolate solutions form oil-in-water emulsions. Emulsification can be characterised in terms of emulsion stability (ES), wherein a high emulsion stability indicates good emulsification. The emulsion stability is the percentage of the emulsified part of a mixture compared to the entire mixture after incubation for a predetermined time period. Preferably, the emulsion stability can be determined as demonstrated in Example 2 or 5.

The term “fermented food product” as used herein refers to food products produced by a method comprising a step of fermentation. Preferred fermented food products according to the invention are plant based fermented food products, which preferably have one or more properties in common with dairy based cheese, such as colour, taste, texture, nutritional content, stability, dispersibility, and/or solubility. In particular, the fermented food product of the invention may have similar texture and/or nutritional content as a dairy based cheese.

The term “gel” as used herein refers to a hydrated polymer network which is essentially continuous throughout its volume. A protein gel is composed of an essentially continuous network of linked protein molecules and a liquid (typically aqueous) solvent, which fills the space within the protein matrix. The protein matrix exerts a strong viscous drag on the solvent molecules, preventing them from flowing freely. The component molecules making up the gel network may be linked by any force, e.g. by ionic, hydrophobic, metallic, polar or covalent bonds.

The term “gelling” as used herein refers to the process wherein protein isolates in solutions form gels. Important gelling properties include gel strength and gel elasticity.

The term “gel elasticity” as used herein refers to how elastic a given gel is. Gel elasticity is calculated as the ratio between elastic work made by gel during decompression and the work made by instrument during compression by a predetermined distance. If the compression and decompression curves follow the same line, then the gel is fully elastic. Gel elasticity may preferably be determined as described in Examples 3 and 7.

The term “gel strength” as used herein is a measure for the force needed to be applied to compress the gel. The gel strength is provided herein as the “peak force”, which is the maximum force applied during gel compression. The higher the peak force (g), the stronger the gel. Gel strength may preferably be determined as described in Examples 3 and 7.

The term “heat treatment” as used herein refers to an incubation at a temperature in the range of 60 to 110° C. for a time period in the range of 1 to 90 min.

The term “homogenization” as used herein refers to at least mixing one or more solids with a liquid to disperse the solids substantially uniformly throughout the liquid.

The term “hydrolysed protein” as used herein refers to proteins, which during processing have been hydrolysed in a step of hydrolysis, such as thermal hydrolysis or enzymatic hydrolysis. As used herein, thermal hydrolysis and enzymatic hydrolysis refers to active steps of hydrolysis specifically targeting hydrolysis of protein. Hydrolysed proteins generally are more soluble than non-hydrolysed proteins.

The term “non-hydrolysed protein” as used herein refers to natural proteins which not have been subjected or exposed to a step of hydrolysis such as targeted enzymatic hydrolysis, during processing.

Natural, non-hydrolysed legume proteins typically have lower solubility than hydrolysed legume proteins. Non-hydrolysed legume proteins typically have better emulsifying and gelling properties than hydrolysed proteins.

The term “isoelectric point (pl)” as used herein is the pH where the overall net charge of a protein is zero. In proteins there may be several charged groups, and at the isoelectric point the sum of all these charges is zero. At a pH above the isoelectric point the overall net charge of the protein will be negative, whereas at pH values below the isoelectric point the overall net charge of the protein will be positive.

The term “isoelectric precipitation” as used herein refers to a method for purification of proteins, which takes advantage of the low solubility of proteins around pH=pl, hence resulting in the decreasing of the repulsive forces and precipitation of the proteins.

The term “air classification” as used herein refers to a method for purification of proteins, which separates materials based on their size, shape and/or density by air streams.

The term “legume” as used herein refers to any plant belonging to the Caesalpiniaceae, Mimosaceae or Papilionaceae families and in particular any plant belonging to the Papilionaceae family. The term “legume” as used herein includes in particular all the plants described in any of the tables contained in the article by R. HOOVER et al. entitled “Composition, structure, functionality and chemical modification of legume starches: a review” Canadian Journal of Physiology and Pharmacology, 1991, 69, pp 79-92.

The term “oil-in-water emulsion” as used herein refers to a dispersion in which a discontinuous lipid (oil) ‘internal’ phase is dispersed in a continuous aqueous ‘external’ phase. In general, the “oil-in-water emulsions” of the invention are emulsified liquid compositions comprising water, plant protein isolates and vegetable fat, and which preferably is free of animal derived products. The oil-in-water emulsions of the invention are useful as starting material for production of dairy product analogues, such as of production of a plant based fermented food product with properties similar to cheese.

The term “legume protein” as used herein refers to protein from legumes. The legume protein may preferably be a “legume protein isolate”, i.e. legume proteins which are at least partly purified.

The term “plant based’ as used herein refers to a product or composition, wherein the large majority, such as at least 80%, preferably at least 90% of the ingredients of said product or composition comprises plants, or plant's part or are derived, isolated or purified from plants. Furthermore, the term “plant based” as used herein also implies that the product or composition is completely free of animal derived products. In addition to said plant derived ingredients, a plant based product or composition may e.g. comprise minerals and microorganisms.

The term “plant protein” as used herein refers to any protein, which is naturally produced in a plant. The plant protein may be purified or partly purified from said plant.

The term “plant protein isolate” as used herein refers to a composition isolated from a plant or part of a plant comprising proteins. Thus, a protein isolate is typically obtained from a natural plant source upon removal of at least a portion of (or a substantial portion of) one or more of the following: insoluble polysaccharide, soluble carbohydrate and other minor constituents.

The terms “legume protein high concentration isolate” and “high concentration legume protein isolate” are used interchangeably herein and refer to a protein composition obtained from legumes. Legume protein high concentration isolates are commonly prepared by milling of pulses and processing involving protein solubilisation followed by isoelectric precipitation. A high concentration legume protein isolate (dry matter) typically comprises at least 70% by weight of protein, preferably in the range 75-90%. Common non-proteinaceous residual materials in protein isolates are lipids. The lipid content typically varies between 0.5 and 10%. Carbohydrate content including fibers is typically below 5%.

The term “legume protein concentrate” as used herein refers to a protein composition obtained from legumes. Legume protein concentrates are commonly prepared by milling followed by air classification to remove starches present in the pulses. The protein content (dry matter) typically varies between 40% to 70% in dependence of the original protein content in pulses, processing details and number of air classification cycles. While the process leads to the reduction of carbohydrate (starch and fiber) content in the protein material it does not lead to its complete elimination, thus carbohydrate is a relatively abundant non-proteinaceous component besides lipids. The carbohydrate content typically varies between 5 and 45%. The lipid content typically varies between 2 and 15%.

The terms “legume protein flour” as well as “protein rich flour” as used herein refers to milled pulses. Legume protein flours are commonly prepared by dry milling of whole, dehulled pulses.

The protein content (dry matter) corresponds to that in the milled pulses and for protein rich varieties of legumes it typically varies between 15 and 40%. Further carbohydrate content and lipid content corresponds to that in the milled pulses. The carbohydrate content typically varies between 45 and 75%. The lipid content can reach up to 25%, however may vary depending on the protein source. Lipid content is typically lower than 25%, typically lower than 15%. For soya flours the lipid content may reach above 20%.

The term “pulse” as used herein refers to the dried seeds of legumes, such as dried peas and dried fava beans.

The term “pulse protein isolate” as used herein refers to a composition comprising at least partly purified protein from pulses.

The term “solubility in water” as used herein is provided as the percentage (%) of proteins in solution after incubation of a dry legume protein isolate with water, preferably by dispersing dry legume protein isolate in water. The terms “solubility of protein” and “aqueous solubility” may be used interchangeably with the term “solubility in water” herein. Accordingly, the terms “solubility of protein concentrate” or the term “solubility of protein isolate” refer to the percentage of proteins of said concentrate or isolate being in solution after incubation of a dry legume protein concentrate or isolate with water (%). Said % is the percentage of the protein in solution compared to the total protein added to the aqueous solvent and is provided as a wt %. Solubility of protein materials can vary based on the source of protein and the preparation method. Preferably, the solubility in water is the percentage of proteins in solution after incubation of 15 wt % dry legume protein isolate or concentrate in water for 90 min. at 50° C. The percentage of proteins in solution may be determined by separation of soluble and insoluble fractions. This may e.g. be done by centrifugation, e.g. at 4700 xG. After separation, the proteins in solution may e.g. be determined by drying of the soluble fraction e.g. in an oven set to 105° C. overnight. In particular, this may be done, as described in Examples 4 and 5.

The water used when determining solubility is preferably either ordinary tap water or pure water. It is preferred that the solubility is determined without pH adjustment. Thus, preferably no pH regulator, e.g. no acid, base or buffer is added to said water.

Other methods for determination of solubility exist, wherein e.g. a pH regulator is added to the water or different temperatures are used. As the solubility of proteins is dependent on both pH and temperature and protein concentration, use of such different methods could provide for variations in determined solubility.

The term “solid” as used herein in relation to the fermented products, refers to a specific structure of the plant based fermented product characterized by high gel strengths when analysed using a texture analyser (peak force preferably not below 10 g, and intermediate gel elasticity (preferably not above 25%).

The term “spreadable” as used herein refers to a composition having a creamy consistency which can be readily distributed as a continuous layer on an edible substrate such as a slice of bread.

The term “starter culture” as used herein refers to a culture comprising one or more different microorganisms. Preferably, the starter culture comprises or even consists of one or more bacterial strains.

The term “vegetable fat” as used herein refers to fat obtained from a plant source, including fats that have been fractionated or blends of fats from plant sources. Vegetable fats that are liquid at ambient temperatures are often referred to as vegetable oils. In this specification the term “vegetable fat” includes such vegetable oils. The fat obtained from a plant source may be modified, for example by hydrogenation. Thus, the term “vegetable fat” as used herein also comprises hydrogenated vegetable fats.

The term “X wt % oil in water emulsion” refers to an oil in water emulsion comprising X % oil or fat by weight.

### Fermented Food Product

The present invention provides a fermented food product, preferably a plant based fermented food product. In particular, the fermented food products of the invention can be used as a substitute for a dairy product.

Thus, preferably the fermented food product has properties similar to cheese, preferably the product has properties similar to feta cheese.

Thus, the fermented food product may be a “ready to eat”, Greek inspired fermented plant based block. In particular it may be a fermented food product, which is rich, smooth and crumbly in texture; and acidic and salty in taste. The fermented food product of the invention may for example be useful for salads, on pasta, roasted or crumbled on soups.

The fermented food products of the invention have a taste, flavour, mouthfeel and texture, which is compelling. The product according to the invention is preferably a ready-to-eat type fresh product, requiring no cooking or heating, although it is possible to heat or cook the product.

The fermented food product of the invention is preferably prepared by fermenting any of the oil-in-water emulsion described herein below in the section “Oil-in-water emulsion”.

Thus, the invention provides a fermented food product comprising:
a) a mixture of legume protein isolates comprising a first legume protein isolate and a second legume protein isolate, wherein the first legume protein isolate has a solubility of the proteins of at least 25% and the second legume protein isolate has a solubility of the proteins of less than 20%, wherein the second legume protein isolate constitutes in the range of 20 to 70 wt % of the total first and second legume protein isolates,
b) a vegetable fat, and
c) water
wherein the product comprises at least 2% proteins.

The first legume protein isolate is preferably a pea protein isolate and said second legume protein isolate is preferably a fava bean protein isolate. The mixture of legume protein isolates may be any of the mixtures described herein below in the section “Mixture of legume protein isolates” and the vegetable fat may be any of the vegetable fats described herein below in the section “Vegetable fat”. In addition, to the aforementioned components, the fermented food product may comprise one or more additional ingredients, such as any of the ingredients described herein below in the section “Other ingredients”.

In one embodiment, the fermented food product has a nutritional profile comparable to conventional cheese, and more preferably comparable to feta cheese. Preferred protein content, fat content and carbohydrate content of the fermented food product is described herein elsewhere.

In one embodiment, the fermented food product has a taste comparable to or even superior to conventional cheese, preferably comparable to or even superior to conventional feta cheese.

In one embodiment, the fermented food product is a semi-soft product. Preferably, the texture of the product is similar to the texture of cheese, and more preferably the texture is similar to the texture of feta cheese.

The texture may be determined by any useful method. The peak load is a measure of the maximum load (g) measured during a test, which is an indication of sample hardness and an important measure of the texture. Thus, it is preferred that the fermented food product of the invention has a peak load comparable to conventional cheese, and more preferably comparable to feta cheese. For example, the peak load may be at least 100 g, such as at least 140 g, for example at least 300 g. In particular, the fermented food product of the invention may have a peak load in the range of 100 to 600 g, such as in the range of 100 to 500 g, for example in the range of 300 to 400 g. Preferably aforementioned peak load is determined using a Brookfield CT3 4500 Texture Analyser with a ball probe attachment (TA18 probe), for example as described in Example 1 below. Whereas the peak load of fermented products preferably are the aforementioned, the peak load of gels before fermentation may be lower as described elsewhere.

In general, the fermented food product of the invention is completely free of animal derived ingredients. Thus, in one embodiment, the fermented food product consists of plant-derived ingredients, microbial derived ingredients, water and salt.

In one embodiment, the fermented food product does not contain soy or ingredients prepared from soy.

In one embodiment, the fermented food product is free of added, exogenous enzymes, wherein exogenous enzymes within the meaning of the present specification are enzymes, which are added to a product in purified or semi-purified form in order to take advantage of their activity. Thus, the fermented food product may comprise legume derived enzymes or enzymes from any of the microorganisms used for fermentation. However, the fermented food product may be free of other enzymes.

In particular, it is preferred that the fermented food product is free of added, exogenous cross-linking enzymes. It is also preferred that the fermented food product is free of added, exogenous transaminase. It is also preferred that the fermented food product is free of added, exogenous glutaminase. It is also preferred that the fermented food product is free of added, exogenous lysyl oxidase. It is also preferred that the fermented food product is free of added, exogenous Factor XIII (fibrin-stabilizing factor). Moreover, it is also preferred that the fermented food product is free of added, exogenous peroxidases, glucose and hexose oxidases, tyrosinases, laccases and sulfhydryl oxidases.

### Oil-In-Water Emulsion

The present invention relates to fermented food products as described above as well as to oil-in-water emulsions useful for the production of such fermented food products.

Thus, the invention provides an oil-in-water emulsion comprising
a) a mixture of legume protein isolates comprising a first legume protein isolate and a second legume protein isolate, wherein the first legume protein isolate has a solubility of the proteins of at least 25% and the second legume protein isolate has a solubility of the proteins of less than 20%, wherein the second legume protein isolate constitutes in the range of 20 to 70 wt % of the total first and second legume protein isolates,
b) a vegetable fat, and
c) water
wherein the oil-in-water emulsion comprises at least 2% protein.

The first legume protein isolate is preferably a pea protein isolate and said second legume protein isolate is preferably a fava bean protein isolate. The mixture of legume protein isolates comprised within said oil-in-water emulsion may be any of the mixtures described herein below in the section “Mixture of legume protein isolates” and the vegetable fat may be any of the vegetable fats described herein below in the section “Vegetable fat”. In addition, to the aforementioned components, the oil-in-water emulsion may comprise one or more additional ingredients, such as any of the ingredients described herein below in the section “Other ingredients”.

Whereas the oil-in-water emulsion may be provided in any useful form, it is preferred that the oil-in-water emulsion is in the form of an oil-in-water emulsion.

Typically, the oil-in-water emulsion is prepared by a method comprising the steps of
providing a protein solution comprising a mixture of legume protein isolates comprising a first legume protein isolate and a second legume protein isolate, wherein the first legume protein isolate has a solubility of the proteins of at least 25% and the second legume protein isolate has a solubility of the proteins of less than 20%, wherein the second legume protein isolate constitutes in the range of 20 to 70% of the total first and second legume protein isolates, wherein the second legume protein isolate constitutes in the range of 20 to 70 wt % of the total first and second legume protein isolates
Subjecting the solution to a step of heat treatment
Mixing said protein solution with at least one vegetable fat to prepare an oil-in-water emulsion

If one or both of the legume protein isolates are provided in dry form, said isolates are preferably hydrated. For example, a solution may be prepared by:
Providing a first legume protein isolate and/or a second legume protein isolate, wherein the first legume protein isolate has a solubility of the proteins of at least 25% and the second legume protein isolate has a solubility of the proteins of less than 20%.
Mixing said first legume protein isolate and/or said second legume protein isolate with water thereby obtaining a protein solution, wherein the first and the second legume protein isolates may be mixed with water separately or together.

If said first legume protein isolate and second legume protein isolate are mixed separately with water, the method may comprise mixing a solution comprising the first legume protein isolate with a solution comprising the second legume protein isolate. If one of the isolates is provided in dry form and the other in solution, said dry isolate may be hydrated either in water or in the solution containing the other isolate.

The first legume protein isolate is preferably a pea protein isolate and said second legume protein isolate is preferably a fava bean protein isolate. The solution comprising said first and second legume protein isolate preferably contains the isolates in any of the ratios described below in the section “Mixture of legume protein isolates”.

Said mixing to prepare an oil-in-water emulsion may be done in any manner allowing formation of an emulsion, and thus typically comprises vigorous mixing and optionally a step of homogenization.

### Legume Proteins

### Solubility

Solubility of protein isolates in water is an important parameter defining the functionality of the proteins. Solubility is well described in several research articles focusing on functional properties of legume proteins (see e.g. (Lam et al., 2018).

Protein rich plant based materials, such as flours, isolates or concentrates, display critical functional properties, such as solubility. As shown herein the solubility is important for emulsifying, gelling and foaming effects. Among the functional properties of proteins, solubility is considered as of key importance and it is hence usually the first functional property determined during development and testing of new protein ingredients (Yalcin, 2007).

The solubility in water of a protein isolate depends on several factors, e.g. the isolation process used during manufacturing, as well as the source, e.g. on the plant and the plant variety. Such variability is reported in scientific literature. For example, in the article of Arrese et al (Arrese, 1991), solubility of different commercial protein isolates was compared after their solubilisation at 1% concentration in deionised water and it was found that the solubility varied between 20% and 84%.

Taherian, 2011 has reported solubility of the pea isolates prepared employing membrane filtration of around 60%. Another example can be found in the work of Stone et al. (Stone, 2015) reporting a substantial difference between solubility of pea protein isolates prepared by salt extraction dialysis (high solubility of 86%-91%), alkali extraction-isoelectric precipitation (intermediate solubility of 63%-64%) and micellar precipitation (low solubility of 43%-49%), while minor differences were also found between different cultivars of pea proteins.

Even though both source and extraction method may impact the solubility, the skilled person can readily identify useful protein isolates. Thus, in the sections “Legume proteins” and “Mixture of legume protein isolates” preferred methods for preparing protein isolates of varying solubility are described. In general, useful protein isolates to be used with the present invention may be prepared by a method comprising extraction and/or solubilisation of proteins, e.g. by dispersing legumes, e.g. milled pulses of legumes in water at high pH followed by precipitation of proteins, e.g. by decreasing pH, and harvesting the precipitate. Alternatively, numerous proteins isolates are commercially available, and their solubility may easily be determined as described herein in Examples 4 and 5.

Numerous legume protein isolates and concentrates are commercially available, and solubility is a property that is typically reported by manufacturers as a part of the technical data. For example, manufacturer of pea protein isolates Roquette includes information about protein isolate solubility in water at pH 7 into their GRAS Notice submitted to FDA (www.fda.gov/media/134207/download). Another example is technical information from company Atura, stating solubility of its chickpea protein isolate 41.3% in its technical product presentation or technical data sheet from lupin protein isolate from company Prolupin stating solubility of 56%.

### Protein Rich Flours, Protein Concentrates and Protein Isolates

### Plant Based Proteins Rich Materials are Typically Prepared in Three Forms:

Protein rich flours: Typically prepared by milling of dehulled pulses. Protein content corresponds to that in pulses and for protein rich varieties of legumes it can reach up to about 40%. Further carbohydrate content (starch and fiber) and lipid content corresponds to that in the pulses. Protein flour compositions typically comprise 45-75% carbohydrates and up to 25% fat.
Protein concentrates: Most commonly prepared by milling followed by air classification to remove starches present in the pulses. Protein content typically varies between 40% to 70% in dependence of the original protein content in pulses, processing details and number of air classification cycles. While the process leads to the reduction of starch content in the protein material it does not lead to its complete elimination, thus starch is a relatively abundant component besides lipids.

Protein concentrates compositions typically comprise 5-45% carbohydrates and 2-15% fat.
Protein isolates: High concentration isolates are typically prepared by milling and processing involving protein solubilisation followed by isoelectric precipitation. Protein content is typically above 70%, preferably in the range 75-90%. Most of the non-proteinaceous residual materials in protein isolates are lipids.

Protein isolate compositions typically comprise 0.5-10% fat and less than 5% carbohydrates.

Functional properties of plant based protein rich flours, concentrates and isolates Important functional properties of legume proteins for use in preparation of fermented food products include solubility, emulsification properties and gelling properties. The functional properties of plant based protein rich flours, concentrates and high concentration protein isolates differ because of the level and nature of non-proteinaceous materials.
Solubility
Emulsification properties are as shown herein affected by the protein purity.
Gelling properties are affected by the protein's degree of hydrolysation and the three dimensional structure, furthermore, the starch components present in flours and concentrations can give rise to gel formation as well. However, gels prepared from protein isolates are based on protein-protein interactions, whereas gels containing high levels of carbohydrates may be based on interactions involving carbohydrates. Thus, to obtain gels based on protein interactions, the predominant use of protein isolates is preferred.

An advantage when using protein isolates, in comparison to protein concentrates or flours, is the low level of starch, fat and fibres. This offers the possibility to control properties of the well-defined raw material during the production process by processing parameters such as pH, ionic strength and temperature.

An additional important advantage of using protein isolates is a lower content of off-flavour compounds in comparison to concentrates and flours.

In one embodiment the legume protein used is protein isolate, and/or a protein concentrate. In general, it is preferred that the products or emulsions of the invention do not comprise protein flours. In a preferred embodiment the legume protein is legume protein isolate or legume protein concentrate. In a more preferred embodiment, the legume protein is legume protein isolate.

The legume protein may be hydrolysed or non-hydrolysed. In a preferred embodiment the legume protein is non-hydrolysed.

Hydrolysis may occur enzymatically or thermally. Hydrolysis may occur if the legume protein is subjected to steps of hydrolysis such as enzymatic treatment and/or thermal treatment during processing.

Enzymatic hydrolysis is the simplest and most common method commercially used to hydrolyse plant proteins. During a process of enzymatic hydrolysis, the protein is typically treated with an enzyme such as an Alcalase in combination with an acidic or alkali solution that degrades the protein to its amino acid constituents. Alternative methods for hydrolysis include extensive heating aiming specifically at hydrolysis and other equal processing steps.

Preferably the protein isolate has not been exposed to an active, intentional step of hydrolysis processing step as described above. Preferably the protein isolate has not been subjected to enzymatic hydrolysis. Preferably the protein isolate has not been subjected to thermal hydrolysis. Preferably the protein is non-hydrolysed.

Preferably the protein is not subjected to a step of hydrolysis during processing.

The legume protein may not have been subjected to a step of high-pressure homogenization prior to formation of emulsion.

### Protein Properties

Plant based fermented food product with properties similar to feta cheese and salad cheese as described in example 1, preferably have a specific texture characterized by a sufficiently solid structure that can be crumbled. When analysed by texture analyser, these structures are characterized by high gel strengths and intermediate elasticity.

Solid cheeses are in principle gelled emulsions of fat stabilised by proteins that can, but don't have to, contain other components such as starches, fibres, hydrocolloids and aromas.

Plant based proteins suitable for manufacturing of salad cheese preferably provide three important functionalities:
Good emulsification of fat
Formation of sufficiently hard gels
Formation of gels that are not too elastic

While it might be difficult to find the combination of the all three properties listed above for individual protein isolates, one achieves the desired combination of properties by mixing two or more protein isolates as disclosed herein.

As taught herein, protein properties such as solubility, gel strength, gel elasticity and emulsification can be controlled and optimised by having protein mixtures of two or more proteins with different properties.

### Solubility

Solubility is a requirement for gelling and emulsification, however high solubility does not entail that the proteins show good gelling or good emulsification properties. As shown herein, it may be preferably to use a mixture of highly soluble proteins and less soluble proteins.

Solubility may preferably be measured gravimetrically after mixing 15 wt % dry protein isolates in water set to 50° C. for 1.5 hour followed by separation of soluble and insoluble fractions, and determining the amount of protein in the soluble fraction. Separation may be done e.g. by centrifugation e.g. at 4700 xG. Determining the amount of protein in the soluble fraction may be done by drying the soluble fraction, e.g. by heating, e.g. by incubation in an oven set to 105° C. overnight. The legume protein isolates are generally used as obtained after isolation. It is preferred that no pH regulator is added. In particular, determination of solubility should be performed in the absence of a pH regulator.

Solubility of proteins is dependent on both pH and temperature. If one protein changes the pH, this can affect the solubility of another protein, if a mixture of two or more proteins are dissolved together.

In one embodiment the solubility is determined by incubating 15 wt % of said protein isolate in water for 90 min. at 50° C. in the absence of pH adjustment

In one embodiment a first legume protein isolate has a solubility of the proteins of at least 25%. In other words, at least 25% of the proteins of a dry legume protein isolate are in solution after incubation of said dry legume protein in water, preferably after incubation in water for 90 min. at 50° C. The second legume protein isolate has a solubility of the proteins of less than 20%. In other words, less than 20% of the proteins of a dry legume protein isolate are in solution after incubation of said dry legume protein in water, preferably after incubation in water for 90 min. at 50° C.

### Emulsification

Some legume proteins, but not all, are capable of forming emulsions. Examples 2 and 6 relate to emulsification of proteins and discloses useful methods for determining emulsifying properties.

The mixture of protein isolates used with the present invention preferably have an emulsifying capacity so that a mixture of said protein isolates in water and oil has an emulsion stability of at least 35%, when said mixture comprises at least 0.15% protein and 15 wt % oil, and wherein the emulsion stability is the % mixture still emulsified after storage for 2 hours at room temperature. The emulsion capacity may in particular be determined as described in Example 2. Alternatively, the emulsion capacity may be determined as described in Example 6 wherein emulsification is achieved by using a high shear homogeniser at 5000 rpm for 120 seconds, and the emulsion stability is the % mixture still emulsified after storage for 24 hours at room temperature.

Emulsification herein is preferably measured using legume protein isolates dispersions in water, such as on 15 wt % legume protein isolate dispersions in water. Dry legume protein isolates are preferably hydrated for 1.5 hours and then subjected to a step of heat treatment. The resulting heat treated legume dispersion is then diluted to different degrees and mixed with oil.

Emulsions for determining emulsion stability may be prepared by mixing rapeseed oil with the diluted legume protein dispersion at any useful ration. Emulsification may be achieved by mixing and/or homogenisation, e.g. by using a mixing tool for 60 seconds. The emulsions are then left to stand in narrow glass tubes (e.g. with a diameter of 20 mm) for a predetermined period of time (e.g. in the range of 1 to 48 h, such as in the range of 1 to 30 h, for example for 2 or 24 h. Emulsion stability (ES) may be determined as a portion of the emulsified part of the mixture:

ES=100%*He/Ht

where He is the height of the emulsified part of the sample in mm and Ht is the total height of the oil/legume solution sample in mm in the tube.

### Mixture of Legume Protein Isolates

The invention provides fermented food products as well as oil-in-water emulsions comprising a mixture of legume protein isolates, which preferably is any of the mixture of legume protein isolates described herein. Preferably, said mixture of legume protein isolates comprise a first legume protein isolate and a second legume protein isolate, wherein the first legume protein isolate has a solubility of the proteins of at least 25% and the second legume protein isolate has a solubility of the proteins of less than 20%, wherein the second legume protein isolate constitutes in the range of 20 to 70% by mass of the total first and second legume protein isolates.

Legume protein isolates may be any preparation of purified or partly purified proteins from legumes. Preferably, “legume protein isolates” is a preparation of purified or partly purified proteins from pulses, and may in such cases be referred to as “pulse protein isolates”.

Within the present specification, legume protein isolates are still referred to as “legume protein isolates” even after they have been mixed with other components, such as water or other ingredients.

The legume protein isolates to be used with the present invention may preferably be protein isolates from the following legumes:
Legumes of the genus Vigna (e.g. cowpea, mung bean),
Legumes of the genus Pisum (e.g. yellow pea),
Legumes of the genus Phaseolum (e.g. french beans, kidney beans, red beans or navy beans),
Legumes of the genus Lens (e.g. yellow lentils),
Legumes of the genus Vicia (e.g. fava beans),
Legumes of the genus Lupinus (lupin beans)
Legumes of the genus Cicer (e.g. chickpea),

Preferably, the legume is not soy, and it is preferred that the products and the oil-in-water emulsions of the invention are free of soy.

The first legume protein isolate preferably has a high solubility. Thus, preferably the proteins of said first legume protein isolate have a solubility of at least 25%, more preferably said first legume protein isolate have a solubility of at least 30%. Said solubility is preferably determined after incubation of 15 wt % of said isolate in water for 90 min. at 50° C. Preferably, said solubility is determined in the absence of pH adjustment. Preferably, solubility is determined as described in Example 4 and 5 herein below.

It is also preferred that the first legume protein isolate has a high globulin content. The storage proteins of legumes can be divided into two main groups:
a) albumins that are highly soluble at different pH values and
b) globulins that are highly soluble at acidic and basic pH, but have low solubility at pH between 4-5.

It is preferred that the first legume protein isolate has a high globulin content, in particular, the first legume protein isolate may have a higher percentage of globulins of the total proteins in the isolate compared to the percentage of globulin of total protein in the legume before isolation. For example, the first legume protein isolate may have at least 1.5 times, such as at least 2 times higher, for example at least 3 times higher percentage of globulins of the total proteins in the isolate compared to the percentage of globulin in the total protein in the legume before isolation.

The main components of the legume globulins are:
Vicilins and their homologues (7S or 8S fraction)—trimeric proteins with Mw of about 170 kDa
Legumins (11S fraction)—hexameric proteins with Mw of about 320-350 kDa

In one embodiment it is preferred that the first legume protein isolate has a high vicilin to legumin ratio. In particular, it is preferred that the first legume protein isolate has a higher vicilin to legumin ratio than the second protein isolate. For example, the first legume protein isolate may have at least 1.5 times, preferably at least 2 times, such as at least 3 times higher vicilin to legumin ratio than the second protein isolate.

It is preferred that the first legume protein isolate is a pea protein isolate.

The second legume protein isolate preferably has a low solubility. Thus, preferably the proteins of said first legume protein isolate have a solubility of less than 20% after incubation of 15 wt % of said isolate in water for 90 min. at 50° C. Preferably, said solubility is determined in the absence of pH adjustment. Preferably, solubility is determined as described in Example 4 herein below.

It is preferred that the second legume protein isolate has a high globulin content, in particular, the second legume protein isolate may have a higher percentage of globulins of the total proteins in the isolate compared to the percentage of globulin of total protein in the legume before isolation. For example, the second legume protein isolate may have at least 1.5 times, such as at least 2 times higher, for example at least 3 times higher percentage of globulins of the total proteins in the isolate compared to the percentage of globulin in the total protein in the legume before isolation.

It is preferred that the second legume protein isolate is a fava bean protein isolate. In a preferred embodiment, the fermented food product or the oil-in-water emulsion comprises a mixture of plant protein isolates comprising pea protein isolate and fava bean protein isolate, wherein the fava bean protein isolate constitutes in the range of 20 to 70 wt % of the total pea and fava bean protein isolate.

The product or the oil-in-water emulsion of the invention comprises at least 0.1% protein, more preferably at least 0.2%, even more preferably at least 1%, yet more preferably at least 2%, for example at least 5%, such as at least 10%, for example at least 14% protein. Whereas there in principle is no specific maximal amount, it is generally preferred that the product or the oil-in-water emulsion comprises at the most 30% protein.

Whereas the product or the oil-in-water emulsion may comprise proteins from various sources, it is preferred that the majority of the protein in the product or the oil-in-water emulsion is either from the first legume protein isolate or the second legume protein isolate. Thus, it is preferred that protein from the first and the second legume isolates constitute at least 70%, such as at least 80%, preferably at least 90% of the total proteins.

Thus, it is preferred that protein from pea and fava bean protein isolates constitute at least 70% by mass, such as at least 80%, preferably at least 90% of the total proteins.

In one embodiment, the product or the oil-in-water emulsion comprise a total of protein from the first and the second legume protein isolates of at least 0.2%, such as at least 1%, for example at least 5%, such as at least 10%, for example at least 14%.

In one embodiment, the product or the oil-in-water emulsion comprise a total of protein from pea and fava bean protein isolates of at least 0.2%, such as at least 1%, for example at least 5%, such as at least 10%, for example at least 14% pea and fava bean protein.

In one embodiment, essentially all proteins within the product or oil-in-water emulsion are selected from the group consisting of first legume protein isolate, second legume protein isolate, yeast protein and bacterial protein.

In one embodiment, essentially all proteins within the product or oil-in-water emulsion are selected from the group consisting of protein from pea protein isolate, fava bean protein isolate, yeast protein and bacterial protein.

As noted above it is preferred that protein of second legume protein isolate constitutes in the range of 20 to 70 wt %, preferably in the range of 20 to 60 wt %, such as in the range of 20 to 50 wt %, for example in the range of 30 to 50 wt % of the total protein from the first and the second protein isolates.

Thus, in embodiments, where the first legume protein isolate is pea protein isolate and the second legume protein isolate is fava bean protein isolate, then it is preferred that protein of fava bean protein isolate constitutes in the range of 20 to 70 wt %, preferably in the range of 20 to 60 wt %, such as in the range of 20 to 50 wt %, for example in the range of 30 to 50 wt % of the total protein from pea and fava bean protein isolates.

This ratio of proteins is particularly beneficial in order to yield an oil-in-water emulsion with good emulsion capacity and gelling properties. Thus, mixing first and second legume protein isolates in specific ratios, and in particular pea and fava protein isolates in specific ratios provide the products with an optimal texture and taste. This invention presents mixture of legume proteins, notably mixtures of pea and fava proteins with specific ratio of pea and fava proteins that provide optimal functionality in terms of:
stability of oil-in-water emulsions containing said protein mixtures and vegetable fat
good elasticity of protein gels based on pea and fava proteins mixture
good gel strength of protein gels based on pea and fava proteins mixture

Thus, preferably, the mixture of proteins is selected to have a ratio of first legume protein isolate to second legume protein isolate so that the mixture has an emulsion stability of at least 35% in a mixture comprising at least 0.15% protein and 15 wt % oil, wherein the emulsion stability is the % mixture still emulsified after storage for 2 hours at room temperature. The emulsion capacity may in particular be determined as described in Example 2.

In particular, preferably, the mixture of proteins is selected to have a ratio of pea to fava bean protein so that the mixture has an emulsion stability of at least 35% in a mixture comprising at least 0.15% protein and 15 wt % oil, wherein the emulsion stability is the % mixture still emulsified after storage for 2 hours at room temperature. The emulsion capacity may in particular be determined as described in Example 2.

It is also preferable that the mixture of proteins is selected so that the mixture can form a gel with good gelling properties after heat treatment. Thus, preferably, the ratio of first legume protein isolate to second legume protein isolate is selected so that an aqueous solution comprising a total of 15% first and second legume protein isolate forms a gel with an elasticity below 25%, such as in the range of 8 to 25% after heat treatment. Preferably, the gel elasticity is determined as described in Example 3 or Example 7 herein below.

Further it is preferable that the ratio of first legume protein isolate to second legume protein isolate is selected so that an aqueous solution comprising a total of 15% first and second legume protein isolate forms a gel with a good gel strength. A good gel strength has a peak force not below 10 g, such as a peak force above 10 g after heat treatment. Preferably, the peak force is determined as described in Example 3 and 7 herein below. As shown herein individual protein isolates often form gels, which are too weak (strength below 10 g) on their own, whereas mixtures of protein isolates can achieve the desired gel strength.

In one embodiment the gels formed by having proteins of the preferred ratio of first legume protein isolate to second legume protein isolate have a peak load of at least 7 g, for example at least 10 g. In a preferred embodiment the gel has a peak load larger than 10 g.

In particular, preferably, the ratio of pea to fava bean protein is selected so that an aqueous solution comprising a total of 15% pea and fava bean protein isolate forms a gel with an elasticity in the range of 8 to 25% after heat treatment. Preferably, the gel elasticity is determined as described in Example 3 herein below.

It is also preferred that the mixture of first legume protein isolate and second legume protein isolate has a solubility of at least 25%, preferably of at least 30% after incubation of 15 wt % of said isolate in water for 90 min. at 50° C. Preferably, said solubility is determined in the absence of pH adjustment. Preferably, solubility is determined as described in Example 4 herein below.

The legume protein high concentration isolates may be prepared by any useful method involving extraction of protein rich fraction from legumes. Common methods include:
Isoelectric precipitation
Salt extraction
Micellar precipitation

The legume protein high concentration isolates may be prepared by any useful method. Such methods may comprise one or more of the following:
Dehulling seeds of legumes, e.g. dehulling pulses
Milling seeds of legumes by dry or wet milling, wherein said seed e.g. may be pulses, such as dehulled pulses, thereby providing legume flours
Solubilisation of proteins by dispersing legume flours in strong alkaline and acid aqueous solution
Solubilisation of proteins by dispersing legume flours in aqueous solutions with high salt concentration
Precipitation/formation of protein rich aggregates by adjusting pH close to isoelectric point
Precipitation/formation of protein rich aggregates by decreasing ionic strength of solution
Collection of protein rich precipitate/aggregate by centrifugation or filtration
Removal residual acid, basis, salt or other soluble components with a significantly lower molecular weight than target proteins by re-dispersion of precipitates/aggregates followed by dialysis or ultrafiltration/membrane-filtration
Pasteurisation
Drying e.g. by spray drying or vacuum drying
Ultrafiltration
Reduction of starch content by air classification
Separation of dietary fibers
Separation of carbohydrates

In a preferred embodiment, the legume protein isolates are prepared by a method allowing enrichment of globulins. Preferably, such methods comprise one or more of the following steps:
Extraction of proteins in an aqueous solution at acidic pH or alkaline pH, preferably at alkaline pH
Isoelectric precipitation

Said acidic pH is preferably a pH below 4, whereas said alkaline pH preferably is a pH above 7.

Isoelectric precipitation takes advantage of the low solubility of proteins around pH=pl, resulting in decreased repulsive forces between proteins and precipitation.

In one embodiment the protein isolate is purified by isoelectric precipitation. In one embodiment the pH is adjusted to around pl using pH regulators. In another embodiment the regulation of pH to around pl results in decreased repulsive forces between proteins, thereby inducing precipitation.

The isoelectric precipitation is preferably performed in manner so that albumins do not precipitate to any significant extent, which results in the protein isolates being enriched in the globulin fraction of the original legume protein material.

In a preferred embodiment the legume protein isolates, and in particular, the pea protein isolate and/or the fav bean protein isolate to be used with the present invention have been prepared by a method comprising the steps of:
Providing pulses, which have optionally been dehulled and milled
Solubilisation of proteins in an aqueous solution at acidic pH or alkaline pH, preferably at alkaline pH
Removal of the insoluble materials
Isoelectric precipitation of the proteins present in solution
Isolation of the protein precipitate
Optionally additional purification step involving re-solubilisation and dialysis or ultrafiltration and/or membrane filtration
Optionally drying the protein precipitate.

In one embodiment, the first legume protein isolate, for example the pea protein isolate has protein content of above 70%, such as above 75% or at least 80%. Preferably the pea protein isolate has a protein content above 70%. It is further preferred that the first legume protein isolate has a low degree of enzymatic hydrolysis applied during the isolation process, in particular it is preferred that method for preparation of the first legume protein isolate does not involve use of added proteolytic enzymes. In particular, it is preferred that the first legume protein isolates have not been subjected to a step of deamidation. First legume protein isolates and in particular, pea protein isolates may be highly functional on their own, however they might form too elastic gels in the context of the target product and furthermore, they may bring along strong pea off-notes to the taste of the product. In one embodiment, the first legume protein isolate may be any of the pea protein isolates described in US patent applications US2019/045826, US2019/021387 and US2020/154753. In one embodiment, the first legume protein isolate is prepared by any of the methods described in European patent application EP3071046 or in Gueguen (1983).

In a preferred embodiment, the legume protein concentrates are prepared by a method comprising milling followed by one or more air classification cycles.

In one embodiment, the second legume protein isolate, e.g. the fava bean protein isolate has a protein content above 70%, such as above 75%, such as at least 80%. Preferably the fava bean protein isolate has a protein content above 70%. It is further preferred that the second legume protein isolate has a low degree of enzymatic hydrolysis applied during the isolation process, in particular it is preferred that method for preparation of the first legume protein isolate does not involve use of added proteolytic enzymes. In particular, it is preferred that the second legume protein isolates have not been subjected to a step of deamidation. Second legume protein isolates and in particular fava bean protein isolates are less functional and on their own they do not form gel with sufficient strength and elasticity as well as they do not sufficiently stabilise fat in their protein matrix. Fava bean protein isolate may be prepared by similar methods as pea protein isolates.

The legume protein isolate may be provided in any useful form, however frequently it is provided as a dry powder. In such, embodiments, the legume protein isolate may be hydrated, e.g. by mixing with water before use. Hydration may be performed for a time period sufficient to dissolve the protein isolates, for example for in the range of 30 min to 5 hours, such as for in the range of 1 to 2 hours.

### Vegetable Fat

In addition to legume protein isolates, the fermented plant products and the oil-in-water emulsions of the invention in general contain a vegetable fat. As noted above, the term “vegetable fat” also comprises vegetable oils. Said vegetable fat may be a crude vegetable fat or it may be processed, for example it may be hydrogenated.

The vegetable fat can be a naturally solid vegetable fat, a vegetable oil, a hydrogenated vegetable fat, a partly hydrogenated vegetable fat, a semisynthetic plant derived fat or a mixture of one or more of the aforementioned, preferably the vegetable fat is a naturally solid vegetable fat, a vegetable oil or mixtures of the aforementioned.

Non-limiting examples of plant fats include corn oil, olive oil, soy oil, peanut oil, walnut oil, almond oil, sesame oil, cottonseed oil, rapeseed oil, canola oil, safflower oil, sunflower oil, flax seed oil, palm oil, palm kernel oil, coconut fat, coconut oil, babassu oil, shea butter, mango butter, cocoa butter, wheat germ oil, or rice bran oil; or margarine. One example of naturally solid vegetable fat is coconut fat.

In one embodiment the vegetable fat is comprises or consists of rapeseed oil, coconut oil, hydrogenated rapeseed oil, hydrogenated coconut oil or a mixture of one or more of the aforementioned.

The product or the oil-in-water emulsion of the invention may comprise any desirable level of vegetable fat. The level of fat may for example dependent on the type of product. Typically, the product or the oil-in-water emulsion of the invention comprise in the range of 10 to 50 wt % vegetable fat, preferably in the range of 10 to 40 wt %, for example in the range of 10 to 30 wt %, such as in the range of 15 to 25 wt % vegetable fat.

The level of vegetable fat may also be dependent on the level of protein. In one embodiment, the product or the oil-in-water emulsion comprises a ratio of total protein to total vegetable fat in the range of 10:1 and 1:500. In one embodiment, the product or the oil-in-water emulsion comprises a ratio of total protein to total vegetable fat in the range of 5:1 and 1:10.

### Other Ingredients

Whereas the main ingredients of the product or the oil-in-water emulsion of the invention are legume protein isolates and vegetable fat and in the case of the product also microorganisms for fermentation, the product or the oil-in-water emulsion may comprise one or more additional ingredients.

The one or more additional ingredients may be chosen based on the desired properties of the final plant based fermented food product.

In one embodiment, the product or the oil-in-water emulsion comprises one or more carbohydrates. Carbohydrates may be added to the product or the oil-in-water emulsion for several reasons, for example the level of carbohydrates may affect the texture, the taste or the fermentation.

Sugars may aid the fermentations. Thus, in particular the oil-in-water emulsion may comprise one or more sugars. The fermented food product may also comprise sugars to the extent that they have not been consumed during fermentation. Said sugars may be any sugars, such as sucrose, glucose, fructose, mannose, steviosides, sativoside, artificial sweeteners, monk fruit extract or combinations thereof. In certain embodiments, examples of suitable carbohydrates may be selected from one or more of the following: sucrose, glucose and fructose.

The product or the oil-in-water emulsion may also comprise flour or starch, such as potato starch. In some embodiments, a carbohydrate component may be a polysaccharide. In some embodiments, the carbohydrate component does not comprise lactose or substantially does not comprise lactose.

It is generally preferred that the product or the oil-in-water emulsion comprises only low levels of carbohydrates. In some embodiments, the products provided herein comprise similar, substantially similar, or reduced amounts of carbohydrate compared with analogous dairy products. Thus, in one embodiment, the product or the oil-in-water emulsion comprises in the range of 0.5 to 10%, preferably in the range of 0.5 to 5%, for example in the range of 1 to 3% carbohydrates. In some embodiments, the product or the oil-in-water emulsion comprises only low levels of carbohydrates, preferably less than 10% (wt %, w/w), preferably less than 5% (wt %), preferably less than 4% (wt %) carbohydrates. As polysaccharides constitute a specific sub-group of carbohydrates it follows that the product or the oil-in-water emulsion in such embodiments preferably also comprises less than 10% (wt %), preferably less than 5% (wt %) polysaccharides.

The product or the oil-in-water emulsion may also contain one or more flavour additives. A flavour additive may be any compound or component added to the product or the oil-in-water emulsion mainly for the purpose of flavour. Examples of flavour additives which may be added to the product or the oil-in-water emulsion include, but is not limited to salt and yeast, for example yeast flakes or yeast extract.

Yeast, such as yeast flakes or yeast extract may also aid the fermentation, and thus at least parts of the yeast derived compounds may be consumed during fermentation. Thus, whereas the oil-in-water emulsion may comprise yeast, for example yeast flakes or yeast extract, the fermented product also comprises yeast derived compounds or components, which are left after fermentation.

The product or the oil-in-water emulsion may also contain one or more additional ingredient, which is a plant based fiber, such as a functional fiber.

The product or the oil-in-water emulsion may also contain one or more pH regulators, however preferably, the pH of the product or the oil-in-water emulsion is not adjusted. Typically, the pH of the oil-in-water emulsion is in the range of 6 to 8. Fermentation may result in a decrease in pH to a more acidic pH.

One advantage of the invention is that the oil-in-water emulsions comprise legume protein mixtures with high emulsion capacity and accordingly, it is not required to add additional emulsifiers. Thus preferably, the products or the oil-in-water emulsions according to the invention do not comprise any added emulsifiers, i.e. they do not comprise emulsifiers apart from the legume protein mixtures or compounds comprised in microorganisms.

### Fermentation

The invention provides a fermented food product. Said food product is produced by fermentation of any of the oil-in-water emulsions described herein above with one or more microorganisms, preferably bacteria.

Typically, a starter culture useful for fermentation of plant based material is used, such as a starter culture free of animal derived material. Starter cultures useful for fermentation of plant based products are commercially available and any such starter culture can be used with the invention.

Useful starter culture typically comprises or even consist of bacterial strains. Thus, the product may comprise one or more bacterial strains, because the product may be prepared by a method comprising a step of fermentation with one or more bacterial strains.

The bacterial strains may be any bacterial strains, for example one or more bacterial strains are selected from lactic acid bacteria and/or a Bifidobacterium or mixtures thereof may be used for fermentation. In particular, the bacterial strains may be one or more selected from the group consisting of bacteria of the genus Bifidobacterium, Lactobacillus, Lactococcus, Leuconostoc, Pediococcus, Streptococcus, or Weissella. In particular, the bacterial strains may be one or more selected from the group consisting of Bifidobacterium animalis, Bifidobacterium bifidum, Bifidobacterium adolescentis, Bifidobacterium breve, Bifidobacterium lactis, Bifidobacterium longum, Lactobacillus acidophilus, Lactobacillus alimentarius, Lactobacillus amylovorus, Lactobacillus brevis, Lactobacillus casei, Lactobacillus curvatus, Lactobacillus delbrueckii subsp. bulgaricus, Lactobacillus delbrueckii subsp. lactis, Lactobacillus fermentum, Lactobacillus helveticus, Lactobacillus paracasei, Lactobacillus plantarum, Lactobacillus sakei, Lactococcus lactis subsp. lactis, Lactococcus lactis subsp. cremoris, Leuconostoc kimchii, Leuconostoc mesenteroides, Leuconostoc pseudomesenteroides, Leuconostoc lactis, Pediococcus acidilactici, Pediococcus damnosus, Pediococcus parvulus, Pediococcus pentosaceus, Streptococcus thermophiles, Weissella cibaria, and Weissella confusa.

Bacteria of the genus Lactobacillus may be based on a polyphasic approach, be reclassified into 25 genera. Thus, one or more bacterial strains to be used for fermentation with the present invention may be of any of these 25 genera, such as of one or more of the genus Lactobacillus, Paralactobacillus, or any of 23 novel genera: Holzapfelia, Amylolactobacillus, Bombilactobacillus, Companilactobacillus, Lapidilactobacillus, Agrilactobacillus, Schleiferilactobacillus, Loigolactobacillus, Lacticaseibacillus, Latilactobacillus, Dellaglioa, Liquorilactobacillus, Ligilactobacillus, Lactiplantibacillus, Furfurilactobacillus, Paucilactobacillus, Limosilactobacillus, Fructilactobacillus, Acetilactobacillus, Apilactobacillus, Levilactobacillus, Secundilactobacillus or Lentilactobacillus (Zheng et al. 2020; https://www.microbiologyresearch.org/content/journal/ijsem/10.1099/ijsem.0.004107)

Fermentation may be performed in any useful manner, which for example may depend on the starter culture employed. The skilled person will be able to select suitable conditions for fermentation. In general, fermentation is performed by incubating the oil-in-water emulsion with said bacteria at a temperature in the range of 25 to 45° C. for in the range of 4 to 24 hours.

### Method

The invention also provides a method for producing fermented food products, in particular plant based fermented food products, wherein said products may have properties similar to cheese, for example properties similar to feta cheese.

Thus, the invention provides methods of producing a fermented food product, said method comprising the steps of
a. providing an oil-in-water emulsion, such as any of the oil-in-water emulsions described in the section “Oil-in-water emulsion” herein above
b. fermenting said oil-in-water emulsion with one or more bacterial strains, e.g. as described in the section “Fermentation” herein above
c. optionally pressing said fermented oil-in-water emulsion thereby obtaining a fermented food product.

Useful methods for producing oil-in-water emulsions are described herein above in the section “Oil-in-water emulsion”.

The fermented oil-in-water emulsion may also be referred to as “curd”.

Typically, the methods comprise a step of pressing the curd. Pressing may be done for several reasons for example in order to reduce water content and/or to shape the product into a desirable shape.

In addition to aforementioned steps, the methods may also comprise a step of ripening of said pressed, fermented oil-in-water emulsion.

The methods may comprise additional steps, for example steps also used in the preparation of conventional cheese. Such steps include for example sterilization/pasteurization.

### Alternative Fermented Food Products

The present invention further provides for other plant based fermented food products, which can be used as substitutes for other dairy products, such as non-solid substitutes for other dairy products.

One such fermented food product has properties similar to spreadable cheese, preferably the product has properties similar to cream cheese.

Such fermented food product has a taste, flavour, mouthfeel and texture, which is compelling. The product according to the invention is preferably a ready-to-eat type fresh product, requiring no cooking or heating, although it is possible to heat or cook the product.

The fermented food product of the invention is preferably prepared by fermenting any of the oil-in-water emulsion described herein above in the section “Oil-in-water emulsion”.

Thus, the invention provides a fermented food product comprising:
a) a mixture of legume protein isolates comprising a first legume protein isolate and a second legume protein isolate, wherein the first legume protein isolate has a solubility of the proteins of at least 25% and the second legume protein isolate has a solubility of the proteins of less than 20%, wherein the second legume protein isolate constitutes in the range of 20 to 70 wt % of the total first and second legume protein isolates,
b) a vegetable fat, and
c) water
wherein the product comprises at least 0.1% proteins, and wherein the solubility is determined by incubating 15 wt % of said protein isolate in water for 90 min. at 50° C. in the absence of pH adjustment.

In preferred embodiments, the first protein isolate is a high concentration legume protein isolate, whereas the second protein isolate is a legume protein concentrate.

One hallmark of fermented food product having properties similar to spreadable cheese is that they may comprise high levels of carbohydrates, such as starch, in contrast to fermented food product having properties similar to feta cheese, which typically contain low levels of carbohydrates. Spreadable cheeses may comprise more than 1% carbohydrate, such as more than 2% carbohydrate, such as more than 3% carbohydrate, such as more than 4% carbohydrate, such as more than 5% carbohydrate, such as more than 10% carbohydrate, such as more than 20% carbohydrate. In a particular embodiment a spreadable cheese comprises between 1 and 8% carbohydrate, such as between 1 and 5% carbohydrate, such as below 5% carbohydrate, such as 4% carbohydrate. In a particular embodiment a spreadable cheese comprises between 1 and 8% polysaccharide, such as between 1 and 5% polysaccharide, such as below 5% polysaccharide, such as below 4% polysaccharide. In a preferred embodiment the fermented food product or the oil-in-water emulsion comprises less than 5% polysaccharide.

The mixture of legume protein may be any of the mixtures described herein in the section “Mixture of legume protein isolates” and the vegetable fat may be any of the vegetable fats described herein below in the section “Vegetable fat”. In addition, to the aforementioned components, the fermented food product may comprise one or more additional ingredients, such as any of the ingredients described herein below in the section “Other ingredients”.

In one embodiment, the fermented food product has a nutritional profile comparable to conventional cheese, and more preferably comparable to a spreadable cheese such as cream cheese.

In one embodiment, the fermented food product has a taste comparable to or even superior to conventional cheese, preferably comparable to or even superior to conventional spreadable cheese such as a conventional cream cheese.

In one embodiment, the fermented food product is semi-soft product. Preferably, the texture of the product is similar to the texture of cheese, and more preferably the texture is similar to the texture of cream cheese.

In general, the fermented food product of the invention is completely free of animal derived ingredients. Thus, in one embodiment, the fermented food product consists of plant-derived ingredients, microbial derived ingredients, water and salt.

In one embodiment, the fermented food product does not contain soy or ingredients prepared from soy.

In one embodiment, the fermented food product is free of added, exogenous enzymes, wherein exogenous enzymes within the meaning of the present specification are enzymes, which are added to a product in purified or semi-purified form in order to take advantage of their activity. Thus, the fermented food product may comprise legume derived enzymes or enzymes from any of the microorganisms used for fermentation. However, the fermented food product may be free of other enzymes.

In particular, it is preferred that the fermented food product is free of added, exogenous cross-linking enzymes. It is also preferred that the fermented food product is free of added, exogenous transaminase. It is also preferred that the fermented food product is free of added, exogenous glutaminase. It is also preferred that the fermented food product is free of added, exogenous lysyl oxidase. It is also preferred that the fermented food product is free of added, exogenous Factor XIII (fibrin-stabilizing factor). Moreover, it is also preferred that the fermented food product is free of added, exogenous peroxidases, glucose and hexose oxidases, tyrosinases, laccases and sulfhydryl oxidases.

Depending on the desired properties of the final plant based fermented food product, the product may comprise one or more additional ingredients.

Even though it is generally preferred to use protein high concentration isolates, alternative products may comprise one or more protein concentrate.

In one embodiment the product comprises one or more protein concentrates derived from legumes. Examples protein concentrates include, but is not limited to chickpea and lentils. In a preferred embodiment the product comprises lentil protein concentrate.

Even though one favoured product has properties similar to feta cheese, the product may have properties similar to a spreadable cheese such as a cream cheese.

In one embodiment the alternative product has properties similar to spreadable cheeses such as cream cheese.

Even though the texture of the product generally is dependent on gelling properties of the proteins, such as gelling elasticity and gel strength, the texture of the alternative product may be more dependent on emulsifying properties.

In one embodiment the alternative product is dependent on emulsifying and stabilising properties of the protein concentrates.

Even though it is generally preferred that the fermented food product does not comprise stabiliser or emulsifier, alternative products may comprise one or more stabilisers and/or emulsifiers.

In one embodiment the product comprises one or more stabilisers and/or emulsifiers. Examples of stabilisers and/or emulsifiers include, but are not limited to xanthan gum, locust bean gum, guar gum, gellan, pectin, lecithins, soluble fibers, polysorbates, and sucrose esters.

In one embodiment such stabiliser or emulsifier is xanthan gum, locust bean gum, guar gum, other gums, gellan, pectin, lecithins, soluble fibers, polysorbates, sucrose esters or other stabilisers or emulsifiers.

Even though it is generally preferred that the proteins are dissolved without use of pH regulator, the proteins may be dissolved with use of a pH regulator.

In one embodiment one or more pH regulators are used to adjust the pH to above 7 to improve solubility of protein isolate, such as chickpea protein isolate. Examples of pH regulators include but are not limited to sodium bicarbonate, sodium hydrogen phosphate, and sodium hydroxide.

The product or the oil-in-water emulsion may also comprise flour or starch, such as potato starch or rice starch. In some embodiments, a carbohydrate component may be a polysaccharide. In some embodiments, the carbohydrate component does not comprise lactose or substantially does not comprise lactose.

Examples of carbohydrates include but are not limited to potato starch, root fruit starch, corn starch, maize starch, rice starch, tapioca starch, pea starch, and other relevant legume based starches.

The product or the oil-in-water emulsion may also contain one or more flavour additives.

A flavour additive may be any compound or component added to the product or the oil-in-water emulsion mainly for the purpose of flavour. Examples of flavour additives which may be added to the product or the oil-in-water emulsion include, but is not limited to salt and yeast, for example yeast flakes or yeast extract.

Yeast, such as yeast flakes or yeast extract may also aid the fermentation, and thus at least parts of the yeast derived compounds may be consumed during fermentation. Thus, whereas the oil-in-water emulsion may comprise yeast, for example yeast flakes or yeast extract, the fermented product also comprises yeast derived compounds or components, which are left after fermentation.

The product or the oil-in-water emulsion may also contain one or more of an additional ingredient, which is a plant based fiber, such as a functional fiber.

Even though the method for preparation of the fermented plant based food product generally comprises a step of pressing the curd in order to reduce water content of the final product, alternative methods may not include a step of pressing the curd.

In one embodiment the method for producing a fermented food product said method comprising the steps of
a. providing an oil-in-water emulsion, such as any of the oil-in-water emulsions described in the section “Oil-in-water emulsion” herein above
b. fermenting said oil-in-water emulsion with one or more bacterial strains, e.g. as described in the section “Fermentation” herein above
c. optionally pressing said fermented oil-in-water emulsion thereby obtaining a fermented food product.

The method may further comprise a step of pH regulation. A step of pH regulation may comprise pH adjustment to pH >6.5, such as pH 7, such as to pH>7 in order to increase the solubility of protein.

In one embodiment the method for producing a fermented food product further comprises a step of pH regulation.

The method may further comprise a step of heat treatment in order to activate the proteins and enable effective emulsification of fat. The step of heat treatment may be heat treatment at 90° C. for 20 minutes.

In one embodiment the method for producing a fermented food product further comprises a step of heat treatment. The heat treatment may be heat treatment at 90° C. for 20 minutes.

The method may further comprise a step of high-pressure homogenisation of the oil-in-water emulsion.

In one embodiment the method for producing a fermented food product further comprises a step of high-pressure homogenisation of the oil-in-water emulsion.

### Items

The invention may further be defined by any of the following items.
1. A fermented food product comprising:
   a) a mixture of legume protein isolates comprising a first legume protein isolate and a second legume protein isolate, wherein the first legume protein isolate has a solubility of the proteins of at least 25% and the second legume protein isolate has a solubility of the proteins of less than 20%, wherein the second legume protein isolate constitutes in the range of 20 to 70% of the total first and second legume protein isolates,
   b) a vegetable fat, and
   c) water
   wherein the product comprises at least 0.1% proteins.
2. A fermented food product comprising:
   a) a mixture of legume protein isolates comprising a first legume protein isolate and a second legume protein isolate, wherein the first legume protein isolate has a solubility of the proteins of at least 25% and the second legume protein isolate has a solubility of the proteins of less than 20%, wherein the second legume protein isolate constitutes in the range of 20 to 70 wt % of the total first and second legume protein isolates,
   b) a vegetable fat, and
   c) water
   wherein the product comprises at least 2% proteins, and wherein the solubility is the percentage of protein in solution after incubation of 15 wt % of the dry protein isolate in water for 90 min. at 50° C. in the absence of pH adjustment.
3. A fermented food product comprising:
   a) a mixture of legume protein isolates comprising pea protein isolate and fava bean protein isolate, wherein the fava bean protein isolate constitutes in the range of 20 to 70% of the total pea and fava bean protein isolate,
   b) a vegetable fat, and
   c) water
   wherein the product comprises at least 0.1% proteins.
4. The product according to any one of the preceding items, wherein the product further comprises one or more bacterial species.
5. The production according to any one of the preceding items, wherein the product is prepared by a method comprising a step of fermentation with one or more bacterial strains.
6. The product according to any one of items 4 to 5, wherein one or more of the bacterial strains is a lactic acid bacteria and/or a Bifidobacterium or mixtures thereof.
7. The product according to any one of items 4 to 6, wherein one or more of the bacterial strain are selected from bacteria of the genus Bifidobacterium, Lactobacillus, Lactococcus, Leuconostoc, Pediococcus, Streptococcus and Weissella.
8. The product according to any one of items 4 to 7, wherein one or more strains of said bacterial species are selected from the group consisting of Bifidobacterium animalis, Bifidobacterium bifidum, Bifidobacterium adolescentis, Bifidobacterium breve, Bifidobacterium lactis, Bifidobacterium longum, Lactobacillus acidophilus, Lactobacillus alimentarius, Lactobacillus amylovorus, Lactobacillus brevis, Lactobacillus casei, Lactobacillus curvatus, Lactobacillus delbrueckii subsp. bulgaricus, Lactobacillus delbrueckii subsp. lactis, Lactobacillus fermentum, Lactobacillus helveticus, Lactobacillus paracasei, Lactobacillus plantarum, Lactobacillus sakei, Lactococcus lactis subsp. lactis, Lactococcus lactis subsp. cremoris, Leuconostoc kimchii, Leuconostoc mesenteroides, Leuconostoc pseudomesenteroides, Leuconostoc lactis, Pediococcus acidilactici, Pediococcus damnosus, Pediococcus parvulus, Pediococcus pentosaceus, Streptococcus thermophiles, Weissella cibaria, and Weissella confusa.
9. The product according to any one of the preceding items, wherein the product has properties similar to cheese.
10. The product according to any one of the preceding items, wherein the product has properties similar to feta cheese.
11. The product according to any one of the preceding items, wherein the product has a peak load of at least 100 g, such as of at least 140 g, for example at least 300 g.
12. The product according to any one of the preceding items, wherein the product has a peak load in the range of 100 to 600 g, such as in the range of 100 to 500 g, for example in the range of 300 to 400 g.
13. The product according to any one of the preceding items, wherein the product has properties similar to spreadable cheese, such as cream cheese.
14. The product according to any one of the preceding items, wherein the product has a gel elasticity below 25%.
15. An oil-in-water emulsion comprising
   a) a mixture of legume protein isolates comprising a first legume protein isolate and a second legume protein isolate, wherein the first legume protein isolate has a solubility of the proteins of at least 25% and the second legume protein isolate has a solubility of the proteins of less than 20%, wherein the second legume protein isolate constitutes in the range of 20 to 70% of the total first and second legume protein isolates,
   b) a vegetable fat, and
   c) water
   wherein the oil-in-water emulsion comprises at least 0.1% protein.
16. An oil-in-water emulsion comprising
   a) a mixture of legume protein isolates comprising a first legume protein isolate and a second legume protein isolate, wherein the first legume protein isolate has a solubility of the proteins of at least 25% and the second legume protein isolate has a solubility of the proteins of less than 20%, wherein the second legume protein isolate constitutes in the range of 20 to 70 wt % of the total first and second legume protein isolates,
   b) a vegetable fat, and
   c) water
   wherein the oil-in-water emulsion comprises at least 2% protein, and wherein the solubility is the percentage of protein in solution after incubation of 15 wt % of the dry protein isolate in water for 90 min. at 50° C. in the absence of pH adjustment, and wherein the oil-in-water emulsion contains less than 5% polysaccharides.
17. An oil-in-water emulsion comprising
   a) a mixture of legume protein isolates comprising a first legume protein isolate and a second legume protein isolate, wherein the first legume protein isolate has a solubility of the proteins of at least 25% and the second legume protein isolate has a solubility of the proteins of less than 20%, wherein the second legume protein isolate constitutes in the range of 20 to 70 wt % of the total first and second legume protein isolates,
   b) a vegetable fat, and
   c) water
   wherein the oil-in-water emulsion comprises at least 2% protein, and wherein the solubility is the percentage of protein in solution after incubation of 15 wt % of the dry protein isolate in water for 90 min. at 50° C. in the absence of pH adjustment, and wherein the oil-in-water emulsion contains less than 5% polysaccharides.
18. An oil-in-water emulsion comprising
   a) a mixture of legume protein isolates comprising pea protein isolate and fava bean protein isolate, wherein the fava bean protein isolate constitutes in the range of 20 to 70% of the total pea and fava bean protein isolates,
   b) a vegetable fat, and
   c) water
   wherein the oil-in-water emulsion comprises at least 0.1% protein.
19. The oil-in-water emulsion according to items 15-18, wherein the oil-in-water emulsion has a peak load of at least 7 g, for example at least 10 g.
20. The product or the oil-in-water emulsion according to any one of the preceding items, wherein the first legume protein isolate is a legume protein high concentration isolate comprising at least 70% protein.
21. The product or the oil-in-water emulsion according to any one of the preceding items, wherein the first legume protein isolate is a legume protein high concentration isolate comprising at least 70%, such as at least 75% protein, such as in the range of 70-95% protein.
22. The product or the oil-in-water emulsion according to any one of the preceding items, wherein the first legume protein isolate is a legume protein high concentration isolate comprising less 5% carbohydrates (including fibers).
23. The product or the oil-in-water emulsion according to any one of the preceding items, wherein the first legume protein isolate is a legume protein high concentration isolate comprising in the range of 0.5 to 10% fat.
24. The product or the oil-in-water emulsion according to any one of the preceding items, wherein the second legume protein isolate is a legume protein high concentration isolate comprising at least 70% protein.
25. The product or the oil-in-water emulsion according to any one of the preceding items, wherein the second legume protein isolate is a legume protein high concentration isolate comprising at least 75% protein.
26. The product or the oil-in-water emulsion according to any one of the preceding items, wherein the second legume protein isolate is a legume protein high concentration isolate comprising less 5% carbohydrates (including fibers).
27. The product or the oil-in-water emulsion according to any one of the preceding items, wherein the second legume protein isolate is a legume protein high concentration isolate comprising in the range of 0.5 to 10% fat.
28. The product or the oil-in-water emulsion according to any one of the preceding items, wherein the first legume protein isolate is a legume protein high concentration isolate comprising at least 70 wt % protein and wherein the second legume protein isolate is a legume protein high concentration isolate comprising at least 70 wt % protein.
29. The product or the oil-in-water emulsion according to any one of the preceding items, wherein the first legume protein isolate has a solubility of the proteins of at least 30%.
30. The product or the oil-in-water emulsion according to any one of the preceding items, wherein the first legume protein isolate has at least 1.5 times, such as at least 2 times higher, for example at least 3 times higher percentage of globulins of the total proteins in the isolate compared to the percentage of globulin in the total protein in the legume before isolation.
31. The product or the oil-in-water emulsion according to any one of the preceding items, wherein the first legume protein isolate is a pea protein isolate.
32. The product or the oil-in-water emulsion according to any one of the preceding items, wherein the second legume protein isolate has at least 1.5 times, such as at least 2 times higher, for example at least 3 times higher percentage of globulins of the total proteins in the isolate compared to the percentage of globulin in the total protein in the legume before isolation.
33. The product or the oil-in-water emulsion according to any one of the preceding items, wherein the second legume protein isolate is a fava bean protein isolate.
34. The product or the oil-in-water emulsion according to any one of the preceding items, wherein the first legume protein isolate has at least 1.5 times, preferably at least 2 times, such as at least 3 times higher vicilin to legumin ratio.
35. The product or the oil-in-water emulsion according to any one of the preceding items, wherein the mixture of legume protein isolates has a solubility of at least 25%, preferably of at least 30%.
36. The product or the oil-in-water emulsion according to any one of the preceding items, wherein the mixture of legume protein isolates provides for a stable emulsion.
37. The product or the oil-in-water emulsion according to any one of the preceding items, wherein one or more of the legume protein isolates has not been subjected to a step of hydrolysis, such as thermal hydrolysis or enzymatic hydrolysis.
38. The product or the oil-in-water emulsion according to any one of the preceding items, wherein one or more of the legume protein isolates has not been subjected to a step of enzymatic hydrolysis.
39. The product or the oil-in-water emulsion according to any one of the preceding items, wherein one or more of the legume protein isolates have not been subjected to a step of high-pressure homogenisation prior to formation of emulsion.
40. The product or the oil-in-water emulsion according to any one of the preceding items, wherein the first and/or the second legume protein isolate is a legume protein concentrate comprising in the range of 40-70% protein.
41. The product or the oil-in-water emulsion according to any one of the preceding items, wherein the first and/or the second legume protein isolate is a legume protein concentrate comprising in the range of 5-45% carbohydrate.
42. The product or the oil-in-water emulsion according to any one of the preceding items, wherein the first and/or the second legume protein isolate is a legume protein concentrate comprising in the range 2-15% fat.
43. The product or the oil-in-water emulsion according to any one of the preceding items, wherein the solubility is determined by incubating 15 wt % of said protein isolate in water for 90 min. at 50° C. in the absence of pH adjustment.
44. The product or the oil-in-water emulsion according to any one of the preceding items, wherein the product of the oil-in-water emulsion comprise at least 0.2%, such as at least 1%, for example at least 5%, such as at least 10%, for example at least 14% protein.
45. The product or the oil-in-water emulsion according to any one of the preceding items, wherein the product or the oil-in-water emulsion comprise at least 0.2%, such as at least 1%, such as at least 2%, for example at least 5%, such as at least 10%, for example at least 14% protein.
46. The product or the oil-in-water emulsion according to any one of the preceding items, wherein the product or the oil-in-water emulsion comprises at the most 30% protein.
47. The product of the oil-in-water emulsion according to any one of the preceding items, wherein the second legume isolate constitutes in the range of 20 to 60%, such as in the range of 20 to 50%, for example in the range of 30 to 50% of the total first and second legume protein isolates.
48. The product of the oil-in-water emulsion according to any one of the preceding items, wherein the fava bean protein isolate constitutes in the range of 20 to 60%, such as in the range of 20 to 50%, for example in the range of 30 to 50% of the total pea and fava bean protein isolates.
49. The product or the oil-in-water emulsion according to any one of the preceding items, wherein the product or the oil-in-water emulsion comprise a total of protein from first and second legume protein isolates of at least 0.2%, such as at least 1%, for example at least 5%, such as at least 10%, for example at least 14%.
50. The product or the oil-in-water emulsion according to any one of the preceding items, wherein the product or the oil-in-water emulsion comprise a total of protein from pea and fava bean protein isolates of at least 0.2%, such as at least 1%, such as at least 2%, for example at least 5%, such as at least 10%, for example at least 14% pea and fava bean protein.
51. The product or the oil-in-water emulsion according to any one of the preceding items, wherein protein of first and second legume protein isolates constitute at least 70%, such as at least 80%, preferably at least 90% of the total proteins.
52. The product or the oil-in-water emulsion according to any one of the preceding items, wherein protein of pea and fava bean protein isolates constitute at least 70%, such as at least 80%, preferably at least 90% of the total proteins.
53. The product or the oil-in-water emulsion according to any one of the preceding items, wherein essentially all proteins within the product or oil-in-water emulsion are selected from the group consisting of proteins from the first legume protein isolate, proteins from the second legume protein isolate, yeast protein and bacterial protein.
54. The product or the oil-in-water emulsion according to any one of the preceding items, wherein essentially all proteins within the product or oil-in-water emulsion are selected from the group consisting of pea protein, fava bean protein, yeast protein and bacterial protein.
55. The product or the oil-in-water emulsion according to any one of the preceding items wherein the second legume protein isolate has protein content of at least 80%.
56. The product or the oil-in-water emulsion according to any one of the preceding items, wherein the second legume protein isolate has not been subjected to a step of deamidation.
57. The product or the oil-in-water emulsion according to any one of the preceding items wherein the first legume protein isolate has protein content of at least 70%.
58. The product or the oil-in-water emulsion according to any one of the preceding items wherein the first legume protein isolate has protein content of at least 80%.
59. The product or the oil-in-water emulsion according to any one of the preceding items, wherein the first legume protein isolate has not been subjected to a step of deamidation.
60. The product or the oil-in-water emulsion according to any one of the preceding items comprising in the range of 10 to 50 wt % vegetable fat, preferably in the range of 10 to 40 wt %, for example in the range of 10 to 30 wt %, such as in the range of 15 to 25 wt % vegetable fat.
61. The product or the oil-in-water emulsion according to any one of the preceding items, wherein the vegetable fat comprises one or more plant oils, and/or semisynthetic plant derived fats.
62. The product or the oil-in-water emulsion according to any one of the preceding items, wherein the vegetable fat comprises one or more plant oils, which optionally may be hydrogenated.
63. The product or the oil-in-water emulsion according to any one of preceding items, wherein the vegetable fat comprises or consists of rapeseed oil or coconut oil, which optionally may be hydrogenated.
64. The product or the oil-in-water emulsion according to any one of the preceding items, wherein the ratio protein:vegetable fat is between 10:1 and 1:500.
65. The product or the oil-in-water emulsion according to any one of the preceding items, wherein the ratio protein:vegetable fat is between 5:1 and 1:10.
66. The product or the oil-in-water emulsion according to any one of the preceding items further comprising one or more carbohydrates.
67. The product or the oil-in-water emulsion according to item 66, wherein at least one carbohydrate is a sugar.
68. The product or the oil-in-water emulsion according to item 67, wherein at least one sugar is sucrose and/or glucose.
69. The product or the oil-in-water emulsion according to any one of items 66 to 68, wherein at least one carbohydrate is starch.
70. The product or the oil-in-water emulsion according to item 69, wherein the starch is potato starch.
71. The product or the oil-in-water emulsion according to any one of items 66 to 70, wherein said product or oil-in-water emulsion comprises in the range of 0.5 to 10%, preferably in the range of 0.5 to 5%, for example in the range of 1 to 3% carbohydrates.
72. The product or the oil-in-water emulsion according to any one of the preceding items, wherein the product or the oil-in-water emulsion contains less than 5% (wt %) carbohydrates.
73. The product or the oil-in-water emulsion according to any one of the preceding items, wherein the product or the oil-in-water emulsion contains less than 4% (wt %) polysaccharides.
74. The product or the oil-in-water emulsion according to any one of the preceding items further comprising one or more flavour additives.
75. The product or the oil-in-water emulsion according to item 74, wherein at least one flavour addition is salt.
76. The product or oil-in-water emulsion according to any one of items 74 to 75, wherein at least one flavour additive is yeast, for example yeast flakes.
77. The product or oil-in-water emulsion according to any one of the preceding items, wherein the product or oil-in-water emulsion is free of added transaminase.
78. The product or oil-in-water emulsion according to any one of the preceding items, wherein the product or oil-in-water emulsions free of added glutaminase.
79. The product or oil-in-water emulsion according to any one of the preceding items, wherein the product or oil-in-water emulsion is free of animal derived ingredients.
80. The product or oil-in-water emulsion according to any one of the preceding items, wherein the product or oil-in-water emulsion is plant based.
81. The product or oil-in-water emulsion according to any one of the preceding items, wherein the product or oil-in-water emulsion consists of plant-derived ingredients, microbial derived ingredients, water and salt.
82. The product or oil-in-water emulsion according to any one of the preceding items, wherein the product or oil-in-water emulsion is free of added emulsifiers.
83. The product or oil-in-water emulsion according to any one of the preceding items, wherein the product or oil-in-water emulsion is free of added emulsifiers.
84. The product or oil-in-water emulsion according to any one of the preceding items, wherein the product or oil-in-water emulsion further comprises stabilisers.
85. The product or oil-in-water emulsion according to any one of the preceding claims, wherein the product or oil-in-water emulsion has a gel elasticity below 25%.
86. A method of producing a fermented food product, said method comprising the steps of
   providing an oil-in-water emulsion according to any one of items 15 to 85
   fermenting said oil-in-water emulsion with one or more bacterial strains
   optionally pressing said fermented oil-in-water emulsion thereby obtaining a fermented food product.
87. The method according to item 86, wherein the oil-in-water emulsion is produced by a method comprising the steps of
   i. Providing a mixture of isolated plant proteins comprising pea protein and fava bean protein, wherein the fava bean protein constitutes in the range of 20 to 70% of the total pea and fava bean protein,
   ii. Mixing said isolated plant proteins with water thereby obtaining a protein solution,
   iii. Subjecting said protein solution to a step of heat treatment
   iv. Mixing said protein solution with at least one vegetable fat to prepare an oil-in-water emulsion.
88. The method according to any one of items 86 to 87, wherein the method further comprising a step of ripening said pressed, fermented oil-in-water emulsion.
89. The product, the oil-in-water emulsion or the method according to any one of the preceding items, wherein the first legume protein isolate has been prepared by a method comprising
   Extraction of proteins in an aqueous solution at acidic pH or alkaline pH, preferably at alkaline pH and
   Isoelectric precipitation
90. The product, the oil-in-water emulsion or the method according to any one of the preceding items, wherein the first legume protein isolate has been prepared by a method comprising
   Extraction of proteins in an aqueous solution at acidic pH or alkaline pH, preferably at alkaline pH and
   Isoelectric precipitation
91. The product, the oil-in-water emulsion or the method according to any one of the preceding items, wherein the first legume protein isolate has been prepared by a method comprising the steps of
   Providing pulses, which have optionally been dehulled and milled
   Extraction of proteins in an aqueous solution at acidic pH or alkaline pH, preferably at alkaline pH
   Removal of the insoluble materials
   Isoelectric precipitation of the protein solution
   Isolation of the protein precipitate
   Optionally drying the protein precipitate.
92. The product, the oil-in-water emulsion or the method according to any one of the preceding items, wherein the second legume protein isolate has been prepared by a method comprising
   Extraction of proteins in an aqueous solution at acidic pH or alkaline pH, preferably at alkaline pH and
   Isoelectric precipitation
93. The product, the oil-in-water emulsion or the method according to any one of the preceding items, wherein the second legume protein isolate has been prepared by a method comprising the steps of
   Providing pulses, which have optionally been dehulled and milled
   Extraction of proteins in an aqueous solution at acidic pH or alkaline pH, preferably at alkaline pH
   Removal of the insoluble materials
   Isoelectric precipitation of the protein solution
   Isolation of the protein precipitate
   Optionally drying the protein precipitate.

### Examples

The invention is further illustrated by the following examples, which however should not be construed as limiting for the invention.

### Example 1: Greek Inspired Fermented Plant Based Block

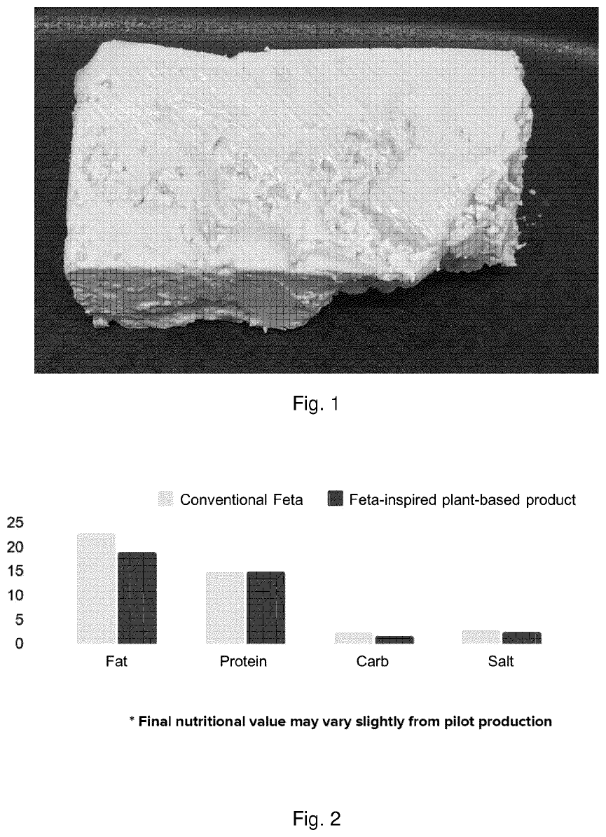

Example 1 describes a plant based fermented food product with properties similar to feta cheese, which is an example of a fermented food product of the invention. The product may also be referred to as “Greek inspired fermented plant based block”. The plant based block is made from a fermented oil-in-water emulsion, consisting of pea protein, fava protein, sucrose, glucose, potato starch, yeast flakes, salt, hydrogenated rapeseed oil and coconut oil, whereof some is hydrogenated. The oil-in-water emulsion is prepared by subjecting a solution comprising the proteins to a step of heat treatment, preparing an emulsion with the fermented with a bacterial starter culture comprising e.g. Lactobacillus, and shaped in a molding/pressing process, to produce a Greek inspired fermented plant based block. An example of a Greek inspired fermented plant based block with properties similar to feta cheese produced as outlined in this Example is shown in FIG. 1.

| Ingredients | Amount |
|---|---|
| (batch size 500 kg) | (kg) |
| Pea protein | 39.5 |
| Fava bean protein | 24 |
| Sucrose | 4.5 |
| Glucose | 2 |
| Potato starch | 2 |
| Yeast flakes | 5 |
| Coconut oil | 55 |
| Fully hydrogenated rapeseed oil + fully | 23.5 |
| hydrogenated coconut oil | |
| Bacterial starter culture comprising e.g. | |
| Lactobacillus | |
| Salt | 6.25 |
| Water | 342 |

It is preferred that the product has properties similar to conventional dairy based cheese. In particular, it is preferred that the Greek inspired fermented plant based block of the invention has properties similar to feta cheese and has a nutritional profile similar to conventional feta cheese.

The final Greek inspired fermented plant based block has a nutritional profile as described below and shown in FIG. 2. The nutritional profile resembles the nutritional profile of traditional feta cheese.

### Nutrition Facts

Per 100 g:
Total fat: 19 g (17.7 g saturated)
Salt: 2.5 g
Total carbohydrate: 1.7 g (sugars 0.1 g)
Protein: 15 g

The texture of the final Greek inspired fermented plant based block was determined using a Brookfield CT3 4500 Texture Analyser with a ball probe attachment (TA18 probe). All samples were measured in triplicate at 20° C.+−0.5 and cut to dimension with a wire cutter. The peak load is a measure of the maximum load (g) measured during a test, which is an indication of sample hardness and an important measure of the texture. Thus, it is preferred that the fermented food product of the invention has a peak load similar to conventional feta cheese. The peak load of a Greek inspired fermented plant based block prepared according to Example 1 and of conventional feta cheese is shown in Table 1.

TABLE 1

| Test parameters | Trigger load | deformation | speed |
|---|---|---|---|
| Sample size | 4.5 g | 6 mm | 0.5 mm/sec |
| 2 × 2 × 2 cm | | | |

TA18 probe

| | | Greek inspired | | |
|---|---|---|---|---|
| | | fermented | Greenvie | |
| | | plant based | vegan | Violife greek |
| | Feta | block | Greek style | block |
| Average Peak | 376.3 | 375.5 | 814.2 | 332.3 |
| Load (g) | | | | |

### Example 2: Emulsification Properties of Mixtures of Pea and Fava Proteins

Emulsification properties were determined in terms of emulsion stability provided by diluted protein solutions containing mixture of pea and fava protein isolates.

The tested emulsions were prepared as follows:
15 wt % legume protein isolate solutions in water were prepared with different ratios of pea and fava components. The pea protein isolates were commercially available isolates from Cosucra, Belgium (Pea protein 1) or Roquette, France (Pea protein 2). The fava protein isolates were commercially available isolates from AGT Food and Ingredient, Canada and Meelunie, Netherlands.

The legume proteins were hydrated for 1.5 hours and then subjected to a step of heat treatment. The resulting heat treated legume solution was then diluted to different degrees, 10x, 20x, 100x and 500x, having 1.5 wt %, 0.75 wt %, 0.15 wt % and 0.03 wt % protein content, respectively.

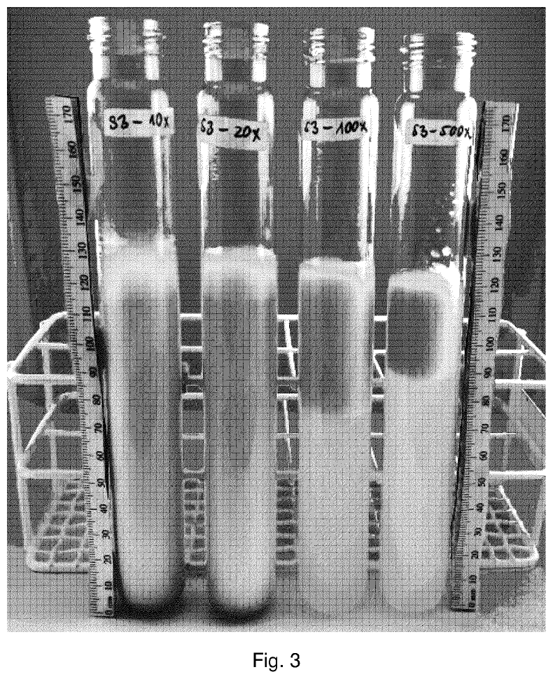

Emulsions were prepared by mixing 30 grams of rapeseed oil with 170 grams of the diluted legume protein solution (15 wt % oil in water emulsion stabilised by legume proteins). Emulsification was achieved by using an electric hand-mixer for 60 seconds. The ready prepared emulsions were left to stand at room temperature in narrow glass tubes with a diameter of 20 mm. Emulsion stability (ES) was accessed after 2 hours and determined as a portion of the emulsified part of the mixture:

$$ES = 100 \% ⋆ He / Ht$$

where He is the height of the emulsified part of the sample in mm and Ht is the total height of the oil/legume solution sample in mm in the tube. An example is shown in FIG. 3, which shows a picture of tubes containing 15 wt % oil-in-water emulsions, stabilized by solutions of pea protein (Pea protein 2) having 1.5 wt %, 0.75 wt %, 0.15 wt % and 0.03 wt % of pea protein after 2 hours.

For the mixture of pea and fava proteins in different ratios, the emulsion stability was decreasing with an increasing part of fava protein in the mixture. The results are provided in Table 2 below.

TABLE 2
Emulsion stability by diluted mixtures of Pea (Pea protein 1) and Fava protein
1. (Dilutions from the original solutions containing 15% proteins in total).

| Pea protein 1/Fava | Emulsified part of oil/protein solution sample | | | |
|---|---|---|---|---|
| protein 1 Sample | 10x dilution | 20x dilution | 100x dilution | 500x dilution |
| 100% Pea (no Fava) | 1.00 | 1.00 | 0.47 | 0.48 |
| 83% Pea + 17% Fava | 1.00 | 1.00 | 0.38 | 0.37 |
| 67% Pea + 33% Fava | 1.00 | 1.00 | 0.38 | 0.37 |
| 50% Pea + 50% Fava | 1.00 | 1.00 | 0.39 | 0.25 |
| 33% Pea + 67% Fava | 1.00 | 0.37 | 0.41 | 0.00 |
| 17% Pea + 83% Fava | 0.38 | 0.38 | 0.43 | 0.00 |
| (No Pea) 100% Fava | 0.40 | 0.40 | 0.32 | 0.00 |

For 10× diluted protein solutions (1.50% of proteins in solution) the emulsion stability decreased for the samples having a fava protein content over 67% and the emulsified fraction of the sample became less than 1.0. For the least concentrated solutions tested, the 500× diluted solutions containing 0.03% of proteins in total, it was not possible to prepare stable emulsion at all, once the fava portion in protein mixture was over 50%.

This show, that the wt % of protein, is of importance for the ratio between pea and fava protein, which can form a stable emulsion. With higher protein wt %, a higher ratio of fava:pea protein is acceptable. For example, Pea protein 1: Fava protein 1: an emulsion containing 1.5 wt % protein and 67% fava protein 1 has good emulsion capacity with 15 wt % fat. Similarly, an emulsion containing 0.75 wt % protein and 50% fava protein 1 also has good emulsion capacity with 15 wt % fat. With 0.03 wt % protein, the emulsion capacity is very low.

The emulsion stability of protein isolates obtained by different manufacturers and their combinations show, that:

At 1.5 wt % protein content, 100% Pea protein 1 or Pea protein 2 are equally good, however at 0.03 wt % protein content, Pea protein 1 is slightly better.

At 1.5 wt % protein content, 50:50 mixtures with pea (Pea protein 1 and Pea protein 2) and Fava (Fava protein 1 and Fava protein 2) are equally good, while Fava protein 2 is better than Fava protein 1 without pea protein.

The results for two different pea protein isolates and two different fava protein isolates are summarised in Table 3.

TABLE 3
Emulsified fraction of oil/protein solution samples containing
30 grams of oil and 170 grams of protein solution after 2
hours after emulsification (i.e. 15 wt % O/W emulsions).

| Protein in water 1.50 wt % (10xd) | Emulsified part of oil/protein solution sample | | |
|---|---|---|---|
| % fava in pea/fava mixture | 0% | 50% | 100% |
| Pea protein 1/Fava protein 1 | 1.00 | 1.00 | 0.39 |
| Pea 1 protein 1/Fava protein 2 | 1.00 | 1.00 | 0.63 |
| Pea protein 2/Fava protein 1 | 1.00 | 1.00 | 0.40 |
| Pea protein 2/Fava protein 2 | 1.00 | 1.00 | 0.62 |
| Protein in water 0.03 wt % (500xd) | Emulsified part of oil/protein solution sample | | |
| % fava in pea/fava mixture | 0% | 50% | 100% |
| Pea protein 1/Fava protein 1 | 0.48 | 0.25 | 0.00 |
| Pea protein 1/Fava protein 2 | 0.48 | 0.32 | 0.00 |
| Pea protein 2/Fava protein 1 | 0.38 | 0.29 | 0.00 |
| Pea protein 2/Fava protein 2 | 0.38 | 0.25 | 0.00 |

### Example 3: Gelling Properties of Mixtures of Pea and Fava Proteins

The tested gels were prepared using 15% solutions of protein mixtures with different ratios of pea and fava proteins (without fat). The pea and fava protein isolates used were the same as described in Example 2. The proteins were hydrated for 1.5 hours and subjected to a step of heat treatment. The heat treated solutions were poured into containers and left to set at 4° C. for 24 hours.

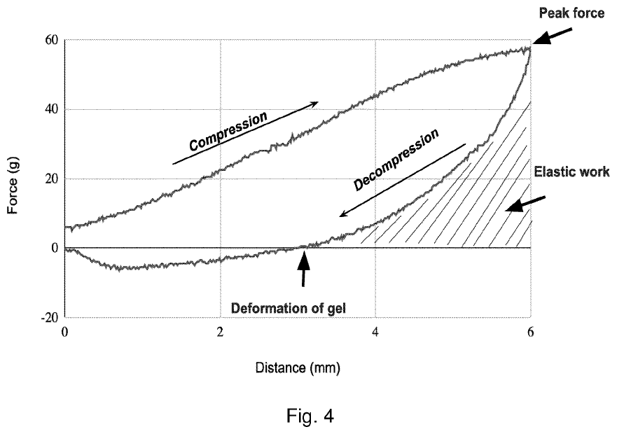

The gelling properties were analysed by Brookfield Texture Analyser using the 12.7 mm ball probe. The gel was compressed by the probe over a distance of 6 mm and then decompressed back. The forces applied on the probe during the compression/decompression process were measured. The experiment resulted in force/distance curves, an example of which is shown in FIG. 4. From these curves, several characteristics of the gel can be extracted.
Gel elasticity is calculated as the ratio between elastic work made by gel during decompression and the work made by instrument during compression to 6 mm. (If the compression and decompression curves would follow the same line, then the gel would be fully elastic.)
Gel strength is extracted in terms of peak force, which is the maximum force applied during the gel compression. The higher the peak force, the stronger was the gel.
Gel deformation is the distance at which zero force is applied upon decompression of the gel. The value corresponds to a residual deformation after the initial compression by 6 mm. The higher the (residual) deformation value, the less the ability of the gel to (elastically) return to its original shape it had before compression.

For the texture of the product, the key gel parameter is the gel elasticity that should be neither too low to avoid “pasty” texture nor too high to avoid “gelatine-like” texture. For samples comprising mixtures of Pea 1 and Fava protein 1 protein, the properties of the formed gels have been studied in detail, with data for both gel elasticity (Table 4), peak force (Table 5), and gel deformation (Table 6).

It is clear, that the elasticity of the gels prepared by different pea protein isolates is affected by their relative proportions. The gel elasticity of gels prepared as described above from different ratios of Pea protein 1 and Fava protein 1 are shown in Table 4. The gel strength and gel deformation of those gels are shown in tables 5 and 6, respectively.

TABLE 4
Elasticity of gels formed by mixed solutions of Pea and
Fava with total protein concentration of 15% (Data for
mixtures of the Pea protein 1 and Fava protein 1).

| Sample | Gel elasticity (%) |
|---|---|
| Pea only | 31% |
| 83% Pea + 17% Fava | 26% |
| 67% Pea + 33% Fava | 18% |
| 50% Pea + 50% Fava | 12% |
| 33% Pea + 67% Fava | 9% |
| 17% Pea + 83% Fava | 6% |
| Fava only | no gel formed |

The results indicate, that adding a very high % of fava protein isolate into protein mixture results in low elasticity, such as that observed for 17:83 mixture of Pea protein 1 and Fava protein 1 with which has an elasticity 6%. On the other hand, the results also indicate, that addition of low amounts of fava (e.g. less than 17% fava (or no fava) protein isolate into protein mixture may result in too high elasticity, such as that observed for 100% Pea protein 1 with elasticity of 31%.

TABLE 5
Peak force data. Gel strength for Pea
protein 1/Fava protein 1 mixtures.

| Sample | Peak force (g) |
|---|---|
| Pea only | 70 |
| 83% Pea + 17% Fava | 63 |
| 67% Pea + 33% Fava | 40 |
| 50% Pea + 50% Fava | 32 |
| 33% Pea + 67% Fava | 25 |
| 17% Pea + 83% Fava | 20 |
| Fava only | no gel formed |

TABLE 6
Gel Deformation. Gel deformation for Pea
protein 1/Fava protein 1 mixtures.

| Sample | Deformation (mm) |
|---|---|
| Pea only | 2.2 |
| 83% Pea + 17% Fava | 2.4 |
| 67% Pea + 33% Fava | 3.3 |
| 50% Pea + 50% Fava | 4.1 |
| 33% Pea + 67% Fava | 4.6 |
| 17% Pea + 83% Fava | 4.8 |
| Fava only | no gel formed |

### Example 4: Protein Solubility

### Measurement of Solubility:

Solubility was measured in water, using commercial protein isolate materials as purchased, without any pH adjustment. 15 wt % dispersion of proteins in water were left to dissolve during stirring for 90 minutes at 50° C. The dispersion was then poured into centrifuge tubes and centrifuged for 30 minutes at 4700 RPM at 20° C., which resulted in separation between the undissolved protein sediments at the bottom of the tube and the supernatant solution containing the dissolved parts of the proteins. The protein content in the supernatant was determined by evaporating the water in an oven at 105° C. and calculating the dry mass weight. Protein solubility was determined as:

Solubility (%)=protein content in the supernatant/protein content in the original dispersion

Data are presented in Table 7 below.

TABLE 7
Solubility of Pea, Fava and Pea/Fava mixtures.

| Sample | Gel elasticity (%) | Protein solubility (%) |
|---|---|---|
| Pea only | 31% | na* |
| 83% Pea + 17% Fava | 26% | 49% |
| 66% Pea + 33% Fava | 18% | 38% |
| 50% Pea + 50% Fava | 12% | 34% |
| 33% Pea + 66% Fava | 9% | 26% |
| 17% Pea + 83% Fava | 6% | 10% |
| Fava only | no gel formed | 4% |

Note:
For Pea 1 and Pea 2 solutions, it was not possible to determine solubility in 15% solution since gel was rapidly formed after stirring was stopped and thus centrifugation has not resulted in separation of sediment and supernatant solution.

### Example 5: Solubility of Protein Isolate and Protein Concentrate

Solubilities of four different legume protein isolates, respectively pea, fava, chickpea and lentil protein isolates, as well as one legume protein concentrate, lentil protein concentrate, were measured gravimetrically after mixing 15% protein solutions in water set to 50° C. for 1.5 hour followed by separation of soluble and insoluble fractions by centrifugation at 4700×G and drying of the resulting supernatant with the soluble fraction in an oven set to 105° C. overnight (Table 8).

No adjustments of pH were done during solubilization, the raw proteins materials were used as received.

TABLE 8
Solubility of the tested legume protein isolates/concentrates.

| Protein | Protein content in the powder | Solubility |
|---|---|---|
| Pea protein isolate | 85% | 35.5% |
| Fava protein isolate | 88% | 4.1% |
| Chickpea protein isolate | 83% | 17.1% |
| Lentil protein isolate | 85% | 6.1% |
| Lentil protein concentrate | 54% | 37% |

### Example 6: Emulsification Properties of Individual Legume Protein Isolates and their Mixtures

Emulsification properties of individual legume protein isolates and their mixtures were determined in terms of emulsion stability provided by diluted protein solutions containing mixtures of pea and fava and chickpea or lentil isolates.

The Emulsions were Prepared as Follows:

Protein isolate solutions in water with total protein concentration of 15% were prepared with different individual protein isolates of with their 50:50 mixtures. The proteins were hydrated for 1.5 hours and then heat treated at 90° C. for 10 minutes. The resulting heat treated legume solution was then diluted 500x, which resulted in protein concentration in the water phase 0.03%.

Emulsions containing 15% of oil were prepared by mixing 15 grams of rapeseed oil with 85 grams of the diluted legume solution. Emulsification was achieved by using a high shear homogeniser at 5000 rpm for 120 seconds. The ready prepared emulsions were left to stand in narrow glass tubes. Emulsion stability (ES) was accessed after 24 hours and determined as a portion of the emulsified part of the mixture as ES=100%*He/Ht, where He is the height of the emulsified part of the sample in mm and Ht is the total height of the oil/legume solution sample in mm in the tube.

The results presented in Table 9 show that it is sufficient with one protein with good emulsion stability in order to secure good emulsification properties of the 50:50 protein isolate mixture.

TABLE 9
Stability of emulsions prepared by pea, chickpea and lentil protein isolates and
their mixtures, with 0.03% of total protein in water.

| Protein mix | Emulsified part of oil/protein solution | | |
|---|---|---|---|
| | Pea only | 50% Pea + 50% Fava | Fava only |
| Pea/Fava | 0.48 | 0.23 | 0.00 |
| | Pea only | 50% Pea + 50% Chickpea | Chickpea only |
| Pea/Chickpea | 0.48 | 0.35 | 0.28 |
| | Pea only | 50% Pea + 50% Lentil | Lentil only |
| Pea/Lentil | 0.48 | 0.28 | 0.00 |
| | Chickpea only | 50% Pea + 50% Lentil | Lentil only |
| Chickpea/Lentil | 0.28 | 0.31 | 0.00 |

### Example 7: Gel Strength and Gel Elasticity of Individual Gel Protein Isolates and their Mixtures

Gel strength and gel elasticity of individual gel protein isolates and their mixtures were analysed. The tested gels were prepared by using 15% solutions of protein mixtures with different ratios of pea and fava components. The proteins were hydrated for 1.5 hours and then heat treated at 90° C. for 10 minutes. The heat treated solutions were poured into containers and left to set in the fridge for 24 hours.

The gel properties were analysed by Brookfield Texture Analyser using the 12.7 mm ball probe. The gel was compressed by the probe over a distance of 6 mm and then decompressed back. The forces applied on the probe during the compression/decompression process were measured. The experiment resulted in force/distance curves, example of which is shown FIG. 4. From these curves, several characteristics of the gel can be extracted.
Gel strength can be extracted in terms of peak force, which is the maximum force applied during the gel compression. The higher the peak force, the stronger the gel was. Desired values are above 10 g.
Gel elasticity was calculated based on compression force vs compression distance curves as the ratio between elastic work made by gel during decompression and the work made by instrument during compression to 6 mm. (If the compression and decompression curves would follow the same line, then the gel would be fully elastic. Desired values are below 25%.

Results for gel strength are presented in Table 10 and for gel elasticity presented in Table 11.

The results show that while the individual protein isolates form too weak gels (strength below 10 grams) or too elastic gels (elasticity above 25%) on their own, one can achieve the desired strength and elasticity by mixing the protein isolates. Combination of Pea and Chickpea proteins which on their own both have too high elasticity (respectively 31% and 33%), results in a desired elasticity below 25% (Table 11).

TABLE 10
Strength of the gels prepared by pea, fava, chickpea and lentil proteins and
their 50:50 mixtures. Values below 10 g are in general too weak gels.

| Protein mix | Peak force (g) | | |
|---|---|---|---|
| | Pea only | 50% Pea:50% Fava | Fava only |
| Pea/Fava | 70 | 25 | no gel formed |
| | Pea only | 50% Pea:50% Chickpea | Chickpea only |
| Pea/Chickpea | 70 | 91 | 166 |
| | Pea only | 50% Pea:50% Lentil | Lentil only |
| Pea/Lentil | 70 | 45 | 7 |
| | Chickpea only | 50% Chickpea:50% Lentil | Lentil only |
| Chickpea/Lentil | 166 | 76 | 7 |

TABLE 11
Elasticity of the gels prepared by pea, fava, chickpea and lentil proteins and
their 50:50 mixtures. Values above 25%: in general, too elastic gels.

| Protein mix | Gel elasticity (%) | | |
|---|---|---|---|
| | Pea only | 50% Pea:50% Fava | Fava only |
| Pea/Fava | 31% | 12% | No gel formed |
| | Pea only | 50% Pea:50% Chickpea | Chickpea only |
| Pea/Chickpea | 31% | 21% | 33% |
| | Pea only | 50% Pea:50% Lentil | Lentil only |
| Pea/Lentil | 31% | 12% | 9% |
| | Chickpea only | 50% Chickpea:50% Lentil | Lentil only |
| Chickpea/Lentil | 33% | 15% | 9% |

### REFERENCES

Arrese et al. Electrophoretic, Solubility and Functional Properties of Commercial Soy Protein Isolates. J. Agric. Food Chem. 1991, 39, 1029-1032
EP 3 071 046: Method for extracting pea proteins (Cosucra group).
Gueguen, J. Legume seed protein extraction, processing, and end product characteristics. Plant Food Hum Nutr 32, 267-303 (1983).
Lam et al. Pea protein isolates: Structure, extraction, and functionality. Food Reviews International 2018, 34, 126-147.
Stone et al. Functional attributes of pea protein isolates prepared using different extraction methods and cultivars. Food Research International 2015, 76, 31-35.
Taherian et al. Comparative study of functional properties of commercial and membrane processed yellow pea protein isolates. Food Research International, 2011, 44, 2505-2514.
Yalcin et al. Solubility properties of barley flour, protein isolates and hydrolysates. Food Chemistry 2007, 104, 1641-1647.
US 2019/045826: Nutritional formulations such as a yoghurt, cream, cream dessert or frozen dessert, comprising a pea protein isolate, and the use of the formulation as a source of protein (Roquette Freres).
US 2019/021387: Nutritional formulations comprising a pea protein isolate (Roquette Freres).
US 2020/154753: Nutritional formulations comprising a pea protein isolate (Roquette Freres).

1. A fermented food product comprising:
a) a mixture of legume protein isolates comprising a first legume protein isolate and a second legume protein isolate, wherein the first legume protein isolate has a solubility of the proteins of at least 25% and the second legume protein isolate has a solubility of the proteins of less than 20%, wherein the second legume protein isolate constitutes in the range of 20 to 70% of the total first and second legume protein isolates,
b) a vegetable fat, and
c) water
wherein the product comprises at least 2% proteins, and wherein the solubility is the percentage of protein in solution after incubation of 15 wt % of the dry protein isolate in water for 90 min. at 50° C. in the absence of pH adjustment.

2. The product according to claim 1, wherein the product comprises and/or has been fermented with one or more bacterial strains, wherein one or more of the bacterial strains are lactic acid bacteria and/or a Bifidobacterium or mixtures thereof.

3. The product according to any one of the preceding claims, wherein the product has a peak load in the range of 100 to 500 g, range of 100 to 600 g, such as in the range of 100 to 500 g, for example in the range of 300 to 400 g.

4. The product according to any one of the preceding claims, wherein the product has a gel elasticity below 25%.

5. An oil-in-water emulsion comprising
a) a mixture of legume protein isolates comprising a first legume protein isolate and a second legume protein isolate, wherein the first legume protein isolate has a solubility of the proteins of at least 25% and the second legume protein isolate has a solubility of the proteins of less than 20%, wherein the second legume protein isolate constitutes in the range of 20 to 70 wt % of the total first and second legume protein isolates,
b) a vegetable fat, and
c) water
wherein the oil-in-water emulsion comprises at least 2% protein, and wherein the solubility is the percentage of protein in solution after incubation of 15 wt % of the dry protein isolate in water for 90 min. at 50° C. in the absence of pH adjustment, and wherein the oil-in-water emulsion contains less than 5% polysaccharides.

6. The product or the oil-in-water emulsion according to any one of the preceding claims, wherein the first legume protein isolate is a legume protein high concentration isolate comprising at least 70% protein and wherein the second legume protein isolate is a legume protein high concentration isolate comprising at least 70% protein.

7. The product or the oil-in-water emulsion according to any one of the preceding claims, wherein the product or the oil-in-water emulsion comprise at least 0.2%, such as at least 1%, such as at least 2%, for example at least 5%, such as at least 10%, for example at least 14% protein.

8. The product or the oil-in-water emulsion according to any one of the preceding claims, wherein the second legume isolate constitutes in the range of 20 to 60 wt %, such as in the range of 20 to 50 wt %, for example in the range of 30 to 50 wt % of the total first and second legume protein isolates.

9. The product or the oil-in-water emulsion according to any one of the preceding claims, wherein the first legume protein isolate is a pea protein isolate.

10. The product or the oil-in-water emulsion according to any one of the preceding claims, wherein the second legume protein isolate is a fava bean protein isolate

11. The product or the oil-in-water emulsion according to any one of the preceding claims, wherein protein of pea and fava bean protein isolates constitute at least 70%, such as at least 80%, preferably at least 90% of the total proteins.

12. The product or the oil-in-water emulsion according to any one of the preceding claims, comprising in the range of 10 to 50 wt % vegetable fat, preferably in the range of 10 to 40 wt %, for example in the range of 10 to 30 wt %, such as in the range of 15 to 25 wt % vegetable fat.

13. The product or the oil-in-water emulsion according to any one of preceding claims, wherein the vegetable fat comprises or consists of rapeseed oil or coconut oil, which optionally may be hydrogenated.

14. The product or the oil-in-water emulsion according to any one of the preceding claims, wherein the ratio protein:vegetable fat is between 10:1 and 1:500.

15. The product or the oil-in-water emulsion according to any one of the preceding claims, wherein essentially all proteins within the product or oil-in-water emulsion are selected from the group consisting of proteins from the first legume protein isolate, proteins from the second legume protein isolate, yeast protein and bacterial protein.

16. The product or the oil-in-water emulsion according to any one of the preceding claims, wherein the product or the oil-in-water emulsion is free of animal derived ingredients.

17. A method of producing a fermented food product, said method comprising the steps of
a. providing an oil-in-water emulsion according to any one of claims 4 to 15
b. fermenting said oil-in-water emulsion with one or more bacterial strains
c. optionally pressing said fermented oil-in-water emulsion
thereby obtaining a fermented food product.
